(19) United States
(12) Patent Application Publication
(10) Pub. No.: US 2025/0019284 A1
(43) Pub. Date: Jan. 16, 2025

(54) SYSTEM AND METHOD OF SUPPLEMENTS DOSING TO REMOVE TOTAL NITROGEN FROM SEWAGE

(71) Applicant: Gregory D. GRAVES, Milan, OH (US)

(72) Inventor: Gregory D. GRAVES, Milan, OH (US)

(21) Appl. No.: 18/220,973

(22) Filed: Jul. 12, 2023

Related U.S. Application Data
(60) Provisional application No. 63/526,173, filed on Jul. 11, 2023.

(51) Int. Cl. C02F 9/00

(52) U.S. Cl. CPC C02F 9/00; C02F 1/004; C02F 2001/007; C02F 1/32; C02F 1/5245; C02F 1/66; C02F 3/302; C02F 3/34; C02F 2101/16; C02F 2209/06; C02F 2209/22; C02F 2301/046

(57) ABSTRACT

A system and method of supplements dosing to remove total nitrogen (TN) from domestic wastewater that can be implemented in a multi-chamber system with a pretreatment chamber fluidly connected to either an anoxic chamber or an aeration chamber, and if connected to the anoxic chamber, the anoxic chamber is fluidly connected to the aeration chamber or tank, and the aeration chamber is fluidly connected to a settling chamber or tank. The system can be used with several methods of organic and alkaline material supplements dosing to remove suspended solids, BOD, ammonia (NH4), nitrate and TN from wastewater.

### FIELD OF THE INVENTION

A system and method of supplements dosing to remove total nitrogen (TN) from domestic wastewater. The system can include multiple chambers or tanks such as a pretreatment chamber or tank fluidly connected to an anoxic chamber or tank, which is fluidly connected to an aeration chamber or tank, and which is fluidly connected to a settling chamber or tank. Alternatively, the system can include a pretreatment chamber or tank fluidly connected to an aeration chamber or tank, and which is fluidly connected to a settling chamber or tank. The system can be used with various supplements dosing methods to remove suspended solids, BOD, ammonia (NH4), nitrate and TN from wastewater.

### BACKGROUND

The most widely used on-site wastewater/sewage treatment systems for individual households have traditionally been either septic systems or aerobic treatment units. Septic systems generally include a septic tank followed by a leaching tile field or a similar absorption device located downstream, but physically on-site of the individual residence. The septic tank allows for larger/heavier solids in the wastewater/sewage to settle out within the tank, while anaerobic bacteria partially degrade any organic material in the waste. The discharge from the septic tank is further treated by dispersion into the soil through any number of soil absorption devices, such as a leaching tile field, whereby bacteria in the soil continue the biodegradation process.

In general, residential wastewater/sewage treatment plants are designed to remove Biological Oxygen Demand (BOD₅) and Total Suspended Solids (TSS). Some plants have the function of removing Total Nitrogen (TN). NSF Standard 245 requires that a residential wastewater/sewage treatment plant should remove more than 50% of TN from sewage during a 26-week certification test period. A certified plant removes TN efficiently under normal conditions. NSF 245 requires that for a wastewater/sewage system to be compliant, it must meet minimum requirements, specifically: Structural integrity; Leakage; Noise; Electrical certification; Access ports; Visual and audible alarms; Flow design; Data plate standards; and Service labels. However, during field application of a wastewater/sewage treatment plant certified by NSF International (NSF) Standard 245 we found that TN removal efficiency is affected significantly by a low pH and high TN influent wastewater. Therefore, in order to maintain a high TN removal efficiency of a wastewater/sewage treatment plant, it was determined that a method of adding supplements to the wastewater/sewage treatment system was needed.

### SUMMARY

A system and method to remove total nitrogen (TN) from wastewater using the addition of supplements to the wastewater/sewage treatment system has been developed. Embodiments of the wastewater/sewage treatment system, in general, can include (i.e., comprise) a number of tanks or chambers, for example, but not limited to, a pretreatment chamber or tank, an anoxic chamber or tank, an aeration chamber or tank, and a settling chamber or tank. The terms “chamber” or “tank” are interchangeable and are used to describe the entire system as well as areas in which different processing of the wastewater or sewage contained therein occurs. As such, the system and method can be accomplished in chambers or tanks that are part of a single contiguous unit or plant as well as in two or more separate units or plants.

While residential wastewater/sewage treatment plants are generally designed to remove Biological Oxygen Demand (BOD₅) and Total Suspended Solids (TSS), some of these plants also have the function of removing Total Nitrogen (TN). NSF Standard 245 requires that a residential wastewater/sewage treatment plant should remove more than 50% of TN from sewage during a 26-week certification test period and a certified wastewater/sewage plant can remove TN efficiently under normal conditions. However, during field application of a wastewater/sewage treatment plant certified by NSF Standard 245, we unexpectedly found that TN removal efficiency is affected significantly by a low pH and a high TN of influent. As a result, to maintain a high TN removal efficiency of a treatment plant, a method of adding supplements to the treatment system was developed.

### BRIEF DESCRIPTION OF THE DRAWINGS

Non-limiting and non-exhaustive embodiments of the disclosed subject matter are described with reference to the following figures, wherein like reference numerals and/or indicia refer to like parts throughout the various views unless otherwise precisely specified.

FIG. 1 is a cross-sectional side view of a wastewater treatment system tank with a pretreatment chamber, an anoxic chamber, an aeration chamber, and a settling chamber, in accordance with one or more embodiments of the disclosed subject matter.

FIG. 2 is a cross-sectional side view of the wastewater treatment system tank of FIG. 1 showing the flow pattern of the effluent water through the chambers in the wastewater treatment system tank, in accordance with one or more embodiments of the disclosed subject matter.

FIG. 3 is a cross-sectional side view of the wastewater treatment system tank of FIG. 1 showing the method of dosing the supplements, in accordance with one or more embodiments of the disclosed subject matter.

FIG. 4 is a flow chart of the method of operation of the system, in accordance with one or more embodiments of the disclosed subject matter.

FIG. 5 is a flow chart of the method of operation of the system, in accordance with one or more embodiments of the disclosed subject matter.

FIG. 6 is a cross-sectional side view of a wastewater treatment system tank with a pretreatment chamber, an aeration chamber, and a settling chamber, in accordance with one or more other embodiments of the disclosed subject matter.

FIG. 7 is a cross-sectional, side view of the wastewater treatment system tank of FIG. 6 showing the flow pattern of the effluent water through the chambers in the wastewater treatment system tank, in accordance with one or more embodiments of the disclosed subject matter.

FIG. 8 is a cross-sectional side view of the wastewater treatment system tank of FIG. 6 showing the method of dosing the supplements, in accordance with one or more embodiments of the disclosed subject matter.

FIG. 9 is a top plan view of the wastewater treatment system tank of FIG. 6, in accordance with one or more embodiments of the disclosed subject matter.

FIG. 10 is an end view of the wastewater treatment system tank of FIG. 6 showing the method of dosing the supplements, in accordance with one or more embodiments of the disclosed subject matter.

FIG. 11 is a flow chart of the method of operation of the system, in accordance with one or more other embodiments of the disclosed subject matter.

FIG. 12 is a flow chart of the method of operation of the system, in accordance with one or more still other embodiments of the disclosed subject matter.

### DETAILED DESCRIPTION

A system and method to remove total nitrogen (TN) from residential wastewater/sewage in non-standard conditions using the addition of supplements to a wastewater/sewage treatment unit/apparatus (the “system”) was developed. Embodiments of the system, in general, can include (i.e., comprise) a pretreatment chamber or tank, an anoxic chamber or tank, an aeration chamber or tank, and a settling chamber or tank. The use of “chamber” or “tank” are interchangeable and are used to describe areas in which different processing of the wastewater/sewage contained therein occurs. As such, the system and method can be accomplished in one or more chambers or tanks that can be part of a single contiguous unit or two or more separate units. Further, in some embodiments, a single tank can contain one or more chambers, which are generally separated by walls with defined fluid communication connections through which the wastewater/sewage can flow between the chambers, either by gravity overflow and/or by physical pumping means, such as, but not limited to, a submergible pump. In general, the flow in the wastewater/sewage treatment unit is from an inlet pipe to an outlet pipe of the wastewater/sewage treatment unit and flow occurs generally by gravity, but some of the wastewater/sewage moving through the system can be returned, for example, but not limited to, by being pumped, to a prior tank or chamber by means of a pump.

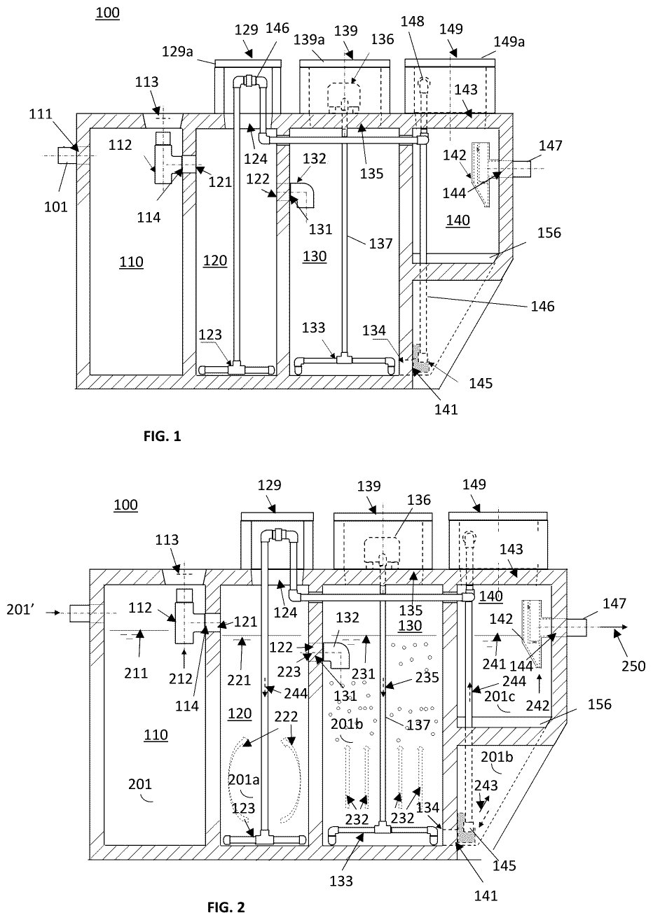

FIG. 1 is a cross-sectional, side view of a wastewater/sewage treatment system unit 100 with a pretreatment chamber 110, an anoxic chamber 120, an aeration chamber 130, and a settling chamber 140, in accordance with one or more embodiments of the disclosed subject matter. The pretreatment chamber 110 includes a pretreatment chamber inlet 111 with an influent pipe 101 through which the wastewater enters the pretreatment chamber 110 and a transfer tee 112 positioned in a pretreatment chamber outlet pipe 114 through which the wastewater exits the pretreatment chamber 110 and enters the anoxic chamber 120. A bottom of the pretreatment chamber inlet 111 is at a height that is above a bottom of the pretreatment chamber outlet 114 to help encourage the flow of the wastewater/sewage through the pretreatment chamber 110 toward the settling chamber 140 and to prevent or reduce backflow of the contents of the pretreatment chamber 110 back into the influent pipe 101. The pretreatment chamber 110 also includes an access opening 113 in a top of the pretreatment chamber 110, which provides physical access to an interior of the pretreatment chamber 110 and to the transfer tee 112. In the pretreatment chamber 110, the incoming influent wastewater/sewage can be treated with a substance to promote clumping of the colloidal particles suspended in the wastewater/sewage, including, for example, a flocculant including, but not limited to, an alum, such as (Al₂(SO₄)₃·14H₂O), to encourage and allow the suspended solids in the wastewater/sewage to come out of suspension and drop to the bottom of the pretreatment chamber 110 and allow clearer wastewater/sewage, i.e., wastewater/sewage with a lower concentration of solids suspended in the wastewater/sewage than in the original influent, to flow through the transfer tee 112, the pretreatment chamber outlet 114, and an anoxic chamber inlet 121 that are in fluid communication with each other and into the anoxic chamber 120.

In FIG. 1, the anoxic chamber 120 also includes an anoxic chamber outlet 122 that is in fluid communication with the aeration chamber 130 via an aeration chamber inlet 131. The anoxic chamber 120 also includes an anoxic chamber access opening 124 in a top of the anoxic chamber 120, and the anoxic chamber access opening 124 provides physical access to an interior of the anoxic chamber 120 through an anoxic chamber riser 129. The anoxic chamber riser 129 generally is sealingly affixed around the anoxic chamber access opening 124 and includes an anoxic chamber riser lid 129a to permit access to the anoxic chamber 120. The anoxic chamber 120 can also include a mixing bar 123 that can be positioned adjacent to a bottom of the anoxic chamber 120 and the mixing bar 123 is in one-way fluid communication with the settling chamber 140 via a sludge return pipe system 146 to receive settled sludge pumped by a sludge return pump 145 from the settling chamber 140. In some embodiments of the presently disclosed subject matter, one or more separate or combined anoxic supplement dispensers, i.e., supplement dispensing units, (not shown) can be located in the anoxic chamber riser 129 and in fluid communication with the anoxic chamber 120 through the anoxic chamber access opening 124. The dispensers can be a single supplement dispenser that can provide a single supplement or a multiple supplement dispenser that can provide two or more supplements either separately from separate compartments or together from a single compartment. In addition, if the two or more supplements are provided separately from separate compartments, they can also be provided at different times.

In FIG. 1, the aeration chamber inlet 131 is in fluid communication with the anoxic chamber 120 via a transfer elbow 132, which opens downwardly into the aeration chamber 130, to receive the anoxically treated wastewater/sewage from the anoxic chamber 120. The aeration chamber 130 includes an aeration chamber outlet 134 that is in fluid communication with the settling chamber 140 via a settling chamber inlet 141 to permit the aerated wastewater/sewage to flow into the settling chamber 140. Similar to the arrangement in the pretreatment chamber 110, an invert of the anoxic chamber inlet 121 is at a height that is above the anoxic chamber outlet 122 to maintain the directional flow of the anoxically treated wastewater/sewage from the anoxic chamber 120 to the aeration chamber 130 and to help prevent or reduce backflow of the contents of the aeration chamber 130 back into the anoxic chamber 120. The aeration chamber 130 further includes an air diffuser 133 that is positioned generally adjacent a bottom of the aeration chamber 130 and that is in fluid communication with an air pump 136, which can be in an aeration chamber riser 139, via an air pump pipe 137 to permit air to be pumped into and to aerate the wastewater/sewage in the aeration chamber 130. The aeration chamber 130 also includes an aeration chamber access opening 135 in a top of the aeration chamber 130, and the aeration chamber access opening 135 provides physical access to an interior of the aeration chamber 130 through the aeration chamber riser 139. The aeration chamber riser 139 generally is sealingly affixed around the aeration chamber access opening 135 to prevent the passage of liquids or solids into or out of the aeration chamber 130. The aeration chamber riser 139 also includes an aeration chamber riser lid 139a to permit access to the air pump 136 and the aeration chamber 130. In some embodiments of the presently disclosed subject matter, one or more separate or combined aeration supplement dispensers, i.e., supplement dispensing units, (not shown) can be located in the aeration or anoxic chamber riser(s) 139 and in fluid communication with the aeration chamber 130 through the aeration chamber access opening 134. The dispensers can be a single supplement dispenser that can provide a single supplement or a multiple supplement dispenser that can provide two or more supplements either separately from separate compartments or together from a single compartment. In addition, if the two or more supplements are provided separately from separate compartments, they can also be provided at different times.

In FIG. 1, the settling chamber inlet 141 is in fluid communication with the aeration chamber 130 via the aeration chamber outlet 134 and the settling chamber 140 further includes a flow equalizer 142 that is connected to and in fluid communication with a settling chamber outlet 144 through which the treated wastewater/sewage exits the settling chamber 140 through an effluent exit pipe 147. The settling chamber 140 also includes a settling chamber access opening 143 in a top of the settling chamber 140, and the settling chamber access opening 143 provides physical access to an interior of the settling chamber 140 through a settling chamber riser 149. The settling chamber riser 149 generally is sealingly affixed around the settling chamber access opening 143 to prevent the passage of liquids or solids into or out of the settling chamber 140. The settling chamber riser 149 also includes a settling chamber riser lid 149a to permit access to a clean-out 148 of the sludge return pipe system 146, the flow equalizer 142, and the settling chamber 140. Optionally, the settling chamber 140 may include a bioreactor 156, for example, but not limited to, an ultraviolet (UV) or membrane bioreactor 156 as a final treatment step in the process of treating the wastewater/sewage.

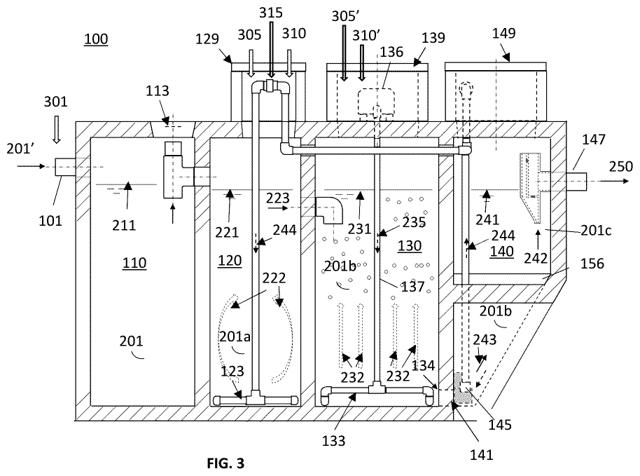

FIG. 2 is a cross-sectional, side view of the wastewater treatment system unit 100 of FIG. 1 showing the flow pattern of the effluent water through the chambers in the wastewater treatment system tank, in accordance with one or more embodiments of the disclosed subject matter. In FIG. 2, the influent wastewater/sewage 201′ enters into the pretreatment chamber 110 through the pretreatment chamber inlet 111 where it has time for a portion of the floating solids to settle to the bottom of the pretreatment chamber 110 to produce a pretreated wastewater/sewage 201. When a level 211 of the pretreated wastewater/sewage 201 in the pretreatment chamber 110 rises up through a bottom 212 of the transfer tee 112 and to a height above the bottom of the pretreatment chamber outlet 112, it can flow through the pretreatment chamber outlet 112 and the anoxic chamber inlet 121 into the anoxic chamber 120. The sludge return pump 145 can pump sludge 244 that has settled at the bottom of the settling chamber 140 up through the sludge return pipe system 146 and back to the mixing bar 123 that is positioned near the bottom of the anoxic chamber 120. When the sludge 244 reaches the mixing bar 123 it passes out through multiple openings that are formed through the mixing bar 123 and into the anoxic chamber 120 to create an upwardly arcing flow 222 of the sludge to mix into the wastewater/sewage within the anoxic chamber 120. As the level 221 of the anoxically treated wastewater/sewage 201a in the anoxic chamber 120 rises to a height above the bottom of the anoxic chamber outlet 122, it flows through the anoxic chamber outlet 122, the aeration chamber inlet 131, and the aeration chamber transfer elbow 132 into the aeration chamber 130. Air 235 from the air pump 136 is forced down the air pump pipe 137 into the air diffuser 133 and out through multiple holes formed in the air diffuser 133 and into the aeration chamber 130 to create an upward flow 232 of the air 235 toward a top level 231 of the anoxically treated wastewater/sewage 201b within the aeration chamber 130 to produce an aerated wastewater/sewage 201b.

In FIG. 2, the aeration chamber outlet 134 is located at the bottom of the aeration chamber 130 and is in fluid communication with the settling chamber inlet 141 to permit the aerated wastewater/sewage 201b to flow from the aeration chamber 130 into the settling chamber 140 through the aeration chamber outlet 134 and a settling chamber inlet 145 located at a bottom of each chamber. A bottom portion of the settling chamber 140 is angled downwardly and inwardly on the three sides not connected to the aeration chamber 130 to form an angled funnel or hopper shape to direct the sludge 244 as it settles to the bottom of the settling chamber 140 toward the sludge return pump 145. As the level of the aerated wastewater/sewage 201b in the settling chamber 140 rises up, it encounters and can pass through the bioreactor 156 to further treat the aerated wastewater/sewage 201b and produce a treated wastewater 201c that continues to rise up and into the flow equalizer 142. When the treated wastewater 201c reaches a height above the bottom of the settling chamber outlet 144, it flows through the settling chamber outlet 144 to the effluent exit pipe 147 and out of 250 the settling chamber 140.

In FIG. 2, as required, the sludge pump can be turned on and the sludge 244 that has settled to the bottom of the settling chamber 140 can be pumped via the sludge return pipe 146 back to and through the mixing bar 123 and into and mixed with the wastewater in the anoxic chamber 120.

### Total Nitrogen Removal Principle

The biochemical TN removal method consists of two treatment processes, i.e., nitrification and denitrification. The biological conversion of ammonium to nitrate nitrogen is called nitrification. Nitrification is a two-step process. Bacteria known as Nitrosomonas convert ammonia (NH₄) and ammonium (NH₄⁺) to nitrite. Next, bacteria called Nitrobacter finish the conversion of nitrite to nitrate. Biological nitrification is the process in which Nitrosomonas bacteria oxidize ammonia to nitrite and Nitrobacter bacteria oxidize nitrite to nitrate. This process results in the overall conversion of ammonia to nitrate. These microorganisms are autotrophic, which means they derive their carbon source from inorganic carbon, such as carbon dioxide and/or bicarbonate. Most other types of organisms in activated sludge are heterotrophic, which means they derive their carbon source from the organic matter in the wastewater. Environmental conditions of pH, alkalinity, temperature, dissolved oxygen concentration and organic carbon loading affect the nitrification process in activated sludge plants. Nitrifiers stop working if the pH gets much below 6.8. From the biological treatment principle, in general, certain amounts of alkalinity and organic carbon can be added to a treatment plant that receives the influent wastewater/sewage at low pH and high TN. Once the carbon source, alkalinity and TN is built at a good ratio relationship, the nitrification process can be completed at a certain level.

The biological denitrification is the process in which microorganisms reduce nitrate to nitrogen gas (N₂). Heterotrophic bacteria normally present in activated sludge perform this conversion when there is no molecular oxygen or dissolved oxygen, and there is sufficient organic matter. The bacteria derive their oxygen from the oxygen contained in the nitrate. The nitrogen gas produced is in the form of nitric oxide (NO), nitrous oxide (N₂O) or nitrogen gas (N₂). The net removal of nitrogen is accomplished by stripping the nitrogen gas formed during denitrification out of the wastewater in a subsequent aeration process. Organic carbon availability is one of the most important factors that affects denitrifying. Based upon the biological principle of the nitrification process and denitrification process, an organic carbon source and alkalinity are two important factors for the two-step TN removal processes.

### Treatment Plant and Field Special Cases

The new method of this invention is treatment plant agnostic, but it initially was tested in a Norweco Hydro-Kinetic (HK) residential wastewater/sewage treatment plant as shown in FIG. 1. The HK wastewater/sewage system is shown and described in U.S. Pat. Nos. 10,167,216 and 10,676,383, which are by the same inventor as the instant application and is available from Norweco Equipment Company of Norwalk Ohio, both of which are hereby incorporated herein in their entireties. A dissolved oxygen (DO) meter was used to measure the levels of oxygen in the wastewater/sewage in the anoxic chamber 120 and in the aeration chamber 130. The flow pattern of the wastewater/sewage into, within, and out of the HK residential wastewater/sewage test treatment plant is shown in FIG. 2. Under normal conditions, the characteristics of most wastewater/sewage from a residential house meets the following requirements:
BOD₅: 100-300 mg/L;
TSS: 100-350 mg/L;
pH: 6-9; and
TN: 35-70 mg/L.

In addition, under normal conditions, the effluent of the Norweco HK residential wastewater/sewage treatment plant can meet NSF Standard 245, which means that the TN removal is more than fifty percent (50%). However, in some areas, because the pH of tap water is less than 6, it causes the wastewater/sewage discharged to the local treatment plants to have a low pH. The TN of wastewater/sewage usually depends upon the lifestyle of the people living in the house and, in general, the amount of wastewater/sewage from a residence is higher in the morning and evening. In some cases, the TN concentration in the wastewater/sewage could be more than 150 mg/L. Under a condition of receiving the wastewater/sewage with low pH, high TN and low BOD conditions, it is difficult, if not impossible, to remove more than fifty percent of TN from the wastewater/sewage without adding supplements. As a result, the TN in the effluent from the wastewater/sewage treatment plant is still high. It is also noted, that low temperatures can also adversely affect the ability of a system to remove TN from the wastewater/sewage.

As described above, an organic carbon source and alkalinity are two important factors for the TN removal processes. In the TN removal process, two certain ratios should be maintained between organic carbon and TN, and between alkalinity and TN. Once these ratios are met, the TN removal function of the plant will be improved, and the TN in the plant effluent will meet the local requirements. For example, these ratio ranges can include 5:1 to 10:1 organic carbon to TN and 3:1 to 10:1 or, in at least one other embodiment, 3.57:1 to 7.14:1 alkalinity to TN.

### Supplements Dosing Method.

In the tests, an agricultural urea solution was applied to artificially increase TN in the influent wastewater/sewage. Under high TN condition, an organic material, for example, but not limited to, regular granular sugar and an alkalinity material, for example, but not limited to, sodium bicarbonate (NaHCO₃) or sodium bisulfate (NaHSO₄), were selected to keep the certain ratios. In some embodiments, a combined supplement solution was prepared by dissolving 1,500 grams of sugar and 200 grams of sodium bicarbonate in 1.0 liters of water.

FIG. 3 is a cross-sectional, side view of the wastewater treatment system unit 100 of FIG. 1 showing the method of dosing the supplements, in accordance with one or more embodiments of the disclosed subject matter. As shown in FIG. 3, a urea solution 301 can be dosed into the influent wastewater/sewage 201 as it enters the pretreatment chamber 110 to increase TN in the influent wastewater/sewage 201 for the testing, and two supplement materials, an organic material (i.e., granular sugar) 305 and an alkalinity material (i.e., Sodium Bisulfate tablets) 310 were added into the anoxic chamber 120, in the form of the combined supplement solution described above. While these were the two supplement materials used for these tests, the performance of the method of the disclosed subject matter is not limited to only the use of these two materials nor are they limited to the form in which the materials were used for the tests. For example, the organic material 305 could also include, but is not limited to, sugar, methanol, ethanol, acetic acid, acetate, and glycerol; and the alkalinity material 310 could include, but is not limited to, sodium carbonate, magnesium hydroxide, and sodium bicarbonate. During the tests, the two supplements were automatically dosed or manually added into the anoxic chamber 120 on a daily basis. The alkalinity material 310 was added to maintain the wastewater/sewage alkalinity between 100 and 250 ppm. In the various embodiments, these two supplements can be added separately or together either manually or using one or more specially designed dosing or dispensing apparatus or devices. In addition, the dosing of the organic and alkaline supplements can be for varying amounts and performed on preset timed intervals, e.g., but not limited to, morning, dinner, or on predetermined regular time intervals such as intervals measured in minutes or hours. The alkalinity material 310 and organic material 305 can be made as a powder, a granular, a pillar, or a tablet shape, or in a liquid depending upon dosing requirements of an apparatus or a device. In one embodiment, where the two supplements can be added separately, the organic material 305 can be added at or adjacent to the anoxic chamber inlet 121 and the alkalinity material 310 can be added at or adjacent to the anoxic chamber outlet 122. In general, when added separately, a 1:1 ratio of organic to alkaline supplements was used. In another embodiment, where the two supplements can be added together, they can be added to the anoxic chamber 120, for example, but not limited to, near the anoxic chamber inlet 121. In general, when the supplements are added together, a range of 2:1 to 7.5:1 ratio of organic to alkaline supplements was used. A DO meter can be used to assist in the dosing of the supplements, by measuring the dissolved oxygen content in the wastewater/sewage in the anoxic chamber 120 and in the aeration chamber 130. In addition, the pH levels in both the anoxic chamber 120 and in the aeration chamber 130 were measured to aid in determining the amounts to dose of each supplement. The system and method can be implemented with combined or separate dispensers of the supplements, for example, in the anoxic chamber 120, there can be separate dispensers for the organic carbon material 305 and the alkaline material 310 or a single dispenser in which both the organic carbon material 305 and the alkaline material 310 can be premixed, or loaded into separate compartments, and provided in a predefined ratio to each other from separate compartments of the single dispenser. In some embodiments of the aeration chamber 130, another single dispenser for the alkaline material 310 can be implemented in the aeration chamber 130 and which can be located in the aeration chamber riser 139.

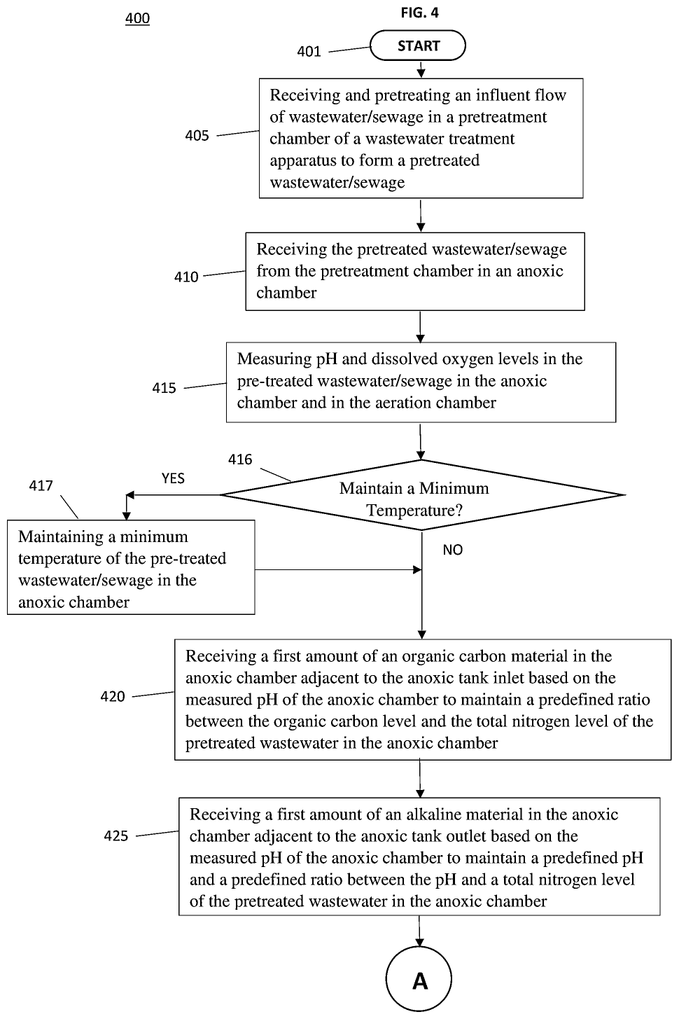

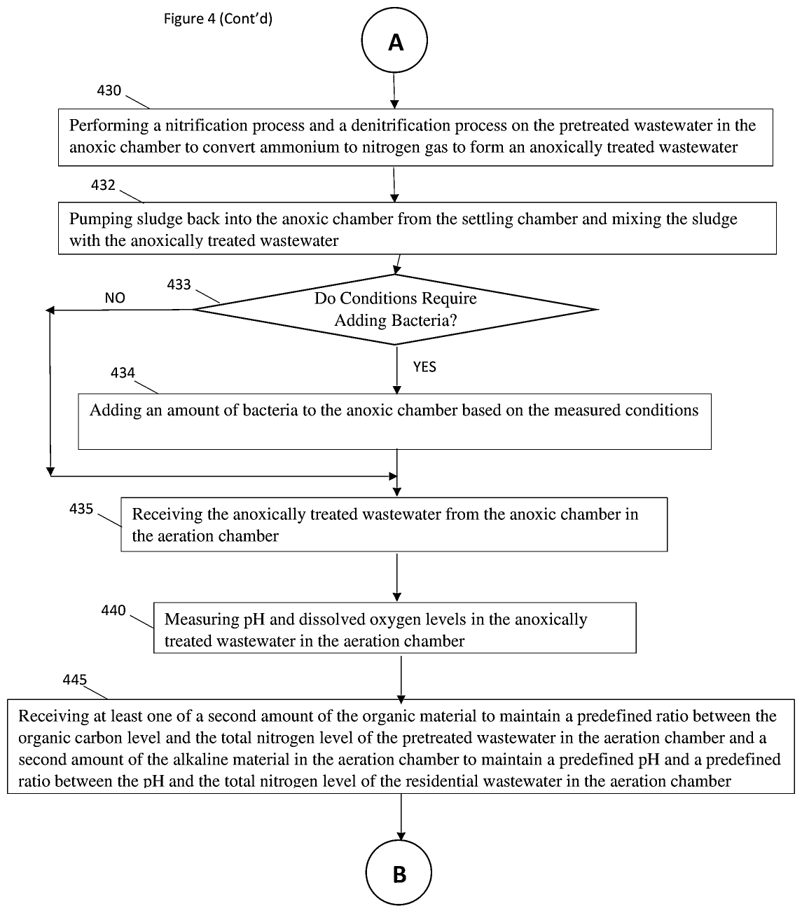

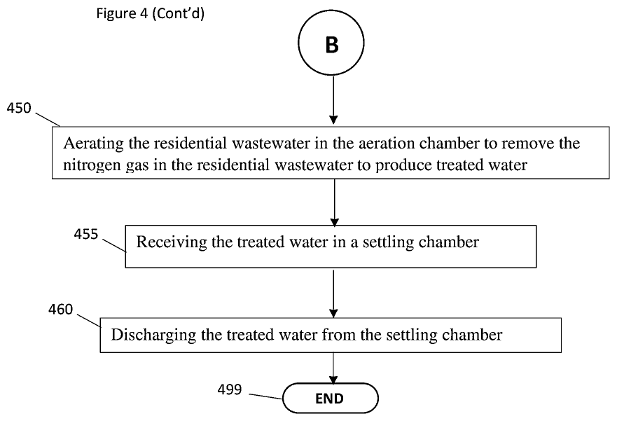

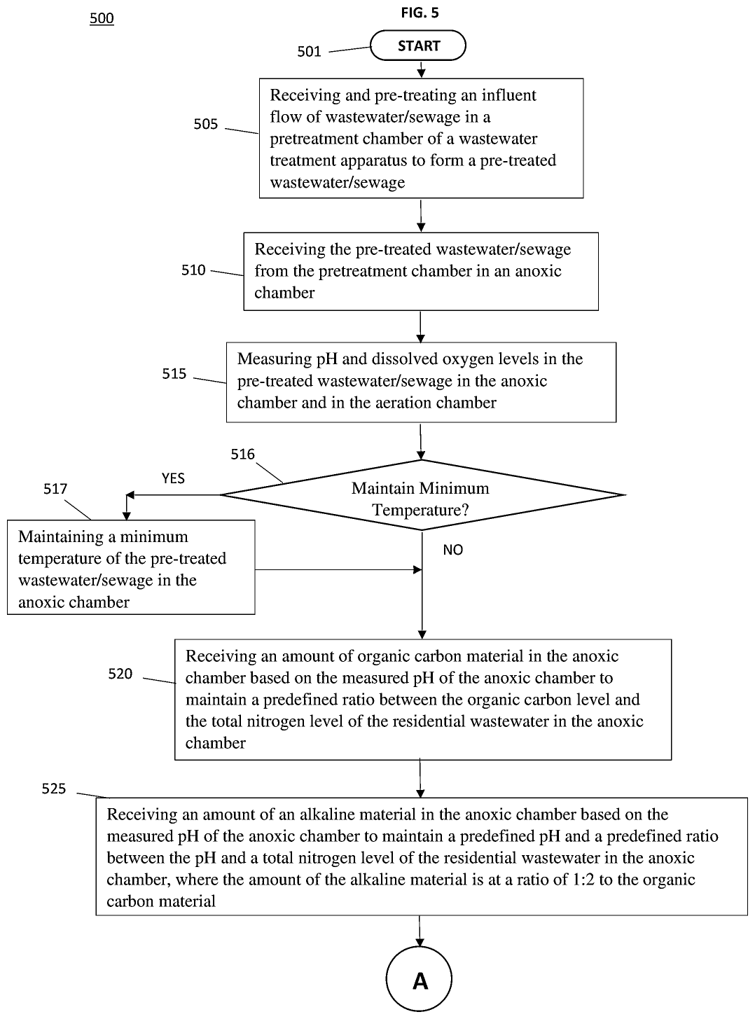

FIG. 4 is a flow chart of an embodiment of a wastewater treatment method 400 of treating wastewater/sewage to remove total nitrogen from an influent residential wastewater flow, in accordance with the disclosed subject matter. While the following embodiment of the method will be described in relation to the specific system 100 shown and described herein, it should be clearly understood that the method can be used in various such systems. In FIG. 4, the wastewater treatment method 400 for removing TN from the influent residential wastewater flow can start (401) by receiving and pre-treating (405) an influent flow of the wastewater/sewage 201 in the pretreatment chamber 110 of the wastewater/sewage treatment unit/apparatus 100. While in the pretreatment chamber 110 the received wastewater/sewage 201 is permitted to settle out some of the floating solids that are present in the received wastewater/sewage 201 to form a pretreated wastewater/sewage 201a. To aid in raising the TN levels for the testing, the pretreatment chamber 110 received a urea 301 supplement, but the addition of the urea 301 is not part of the normal operation of the system. The method 400 can then continue by receiving (410) the pretreated wastewater/sewage 201a from the pretreatment chamber 110 in the anoxic chamber 120. The method 400 can continue by measuring (415) pH and dissolved oxygen levels in the pretreated wastewater/sewage 201a located in the anoxic chamber 120 and in an anoxically treated wastewater/sewage 201b located in the aeration chamber 130 to determine and control the amounts of supplementary materials that should be added to the pretreated wastewater/sewage 201a in the anoxic chamber 120. The method 400 can optionally compare (415) the measured pH and dissolved oxygen levels in the anoxic chamber 120 and the aeration chamber 130 to determine the proper amount of the supplements that need to be added to the aeration chamber 130. The method 400 can continue by determining (416) whether to optionally include maintaining (417) a minimum temperature of the pretreated wastewater/sewage 201a in the anoxic chamber 110, which control can be based on a measured temperature level of the pretreated wastewater/sewage 201a in the anoxic chamber 110. The temperature control can be automatic based on: predefined historical levels; real time predetermined levels; or timed, based on the time of day, the season, or both.

In FIG. 4, the method 400 can continue by receiving (420) an amount of organic carbon material 305 in the anoxic chamber 120. This organic carbon material 305 can be delivered manually or automatically by, for example, but not limited to, a first dispenser based on the measured pH of the pretreated wastewater/sewage 201a in the anoxic chamber. In one or more embodiments of the disclosed subject matter, the organic carbon material 305 can be added adjacent to the anoxic chamber inlet 121 to maintain a predefined ratio between the organic carbon level and the TN level of the pretreated wastewater/sewage 201a in the anoxic chamber 120. The method 400 can then continue by receiving (425) an amount of an alkaline material 310 in the anoxic chamber. The alkaline material 310 can be delivered manually or automatically by, for example, but not limited to, a second dispenser based on the measured pH of the anoxic chamber and delivered adjacent to an outlet of the anoxic chamber to maintain a predefined pH and a predefined ratio between the pH and the TN level of the pretreated wastewater/sewage 201a in the anoxic chamber. It is also possible that both the organic carbon material 305 and the alkaline material 310 are delivered together, so in this embodiment of the method 400, both materials could be provided from the first dispenser. In general, a ratio of the organic carbon material 305 to the alkaline material 310 added can be in a range from 2:1 to 7.5:1, especially when the organic carbon material 305 and the alkaline material 310 are dosed together either manually or from a single dispenser. The method 400 can continue by performing (430) a nitrification process and a denitrification process on the residential wastewater in the anoxic chamber to convert ammonium to nitrogen gas and process the pretreated wastewater/sewage 201a into the anoxically treated wastewater/sewage 201b to be passed to the aeration chamber 130. The method 400 can include pumping (432) the sludge 244 back from the settling chamber 140 into the anoxic chamber 120 to be mixed with the pretreated wastewater/sewage 201a. Depending on the measured conditions of the pretreated wastewater/sewage 201a and/or the anoxically treated wastewater/sewage 201b, the method 400 may continue by determining (433) whether to optionally include adding (434) an amount of at least one bacteria 315 to the anoxic chamber 120 based on the measured conditions. In general, if it is determined (433) that a bacteria 315 is to be added, it can be added manually or automatically via a feeder system. Further, if needed, additional chemical treatments can be added to the method 400, depending on the specific characteristics of the wastewater/sewage being treated, for example, but not limited to, chemicals to remove phosphates, chemicals for disinfection, microbicides for disinfection, chemicals for de-chlorination, Vitamin C for de-chlorination, and bacteria and enzymes for removing grease, fats, and oils. Similarly, a non-chemical treatment system with Ultraviolet (UV) light for disinfection can be used.

In FIG. 4, the method 400 can continue by receiving (435) the anoxically treated wastewater/sewage 201ab from the anoxic chamber 120 in the aeration chamber 130 and measuring (440) pH and dissolved oxygen levels in the anoxically treated wastewater/sewage 201b in the aeration chamber 130. The method 400 can then continue by receiving (445) a second amount of the alkaline material 310′ in the aeration chamber 130 to maintain a predefined pH and a predefined ratio between the pH and the TN level of the anoxically treated wastewater/sewage 201b in the aeration chamber. The second amount of the alkaline material 310′ can be provided based on the measured pH of the aeration chamber and provided either manually or from the second dispenser or a third dispenser, depending on whether the first & second dispensers used in the anoxic chamber 120 are separate or combined. The method 400 can then continue by aerating (450) the anoxically treated wastewater/sewage 201b in the aeration chamber 130 to remove the nitrogen gas from the anoxically treated wastewater/sewage 201b to produce treated water 201c. The aerating (450) can be accomplished by using the air pump 136 to pump air 235 down the air pump pipe 137 and out through the air diffuser 133 and into the aeration chamber 130 to mix the air 235 with the anoxically treated wastewater/sewage 201b to produce the treated water 201c. The method 400 can then continue by receiving (455) the treated water 201c in the settling chamber 140 and then discharging (460) the treated water 201c from the settling chamber 140 through the flow equalizer 142 and the settling chamber outlet 144 into the effluent exit pipe 147.

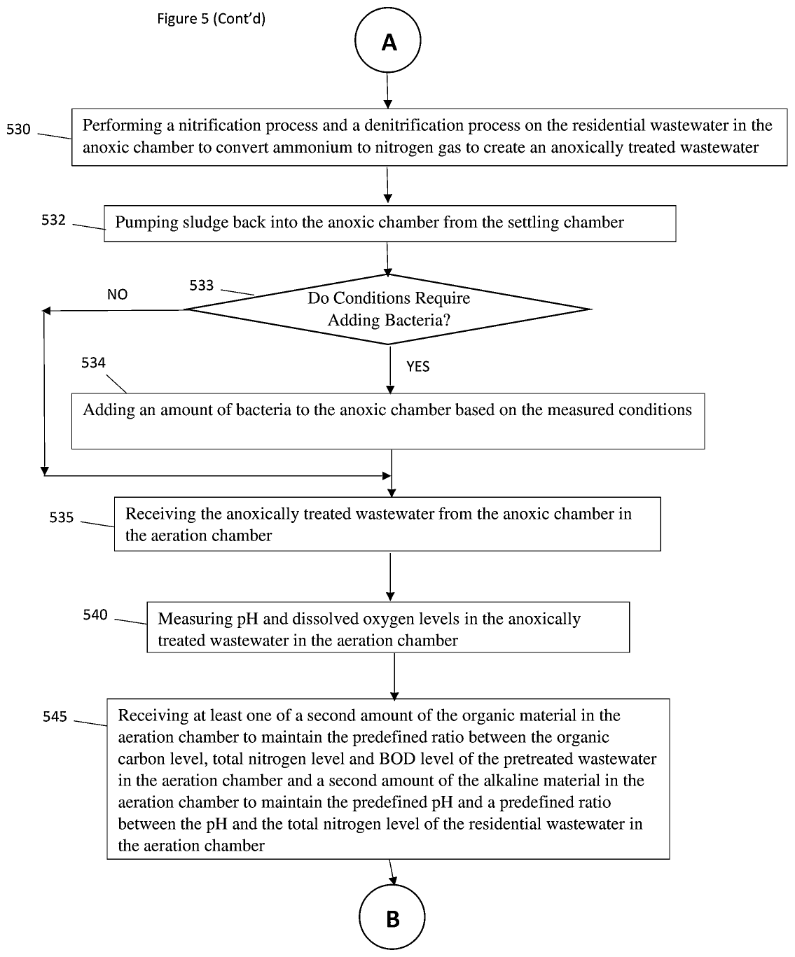

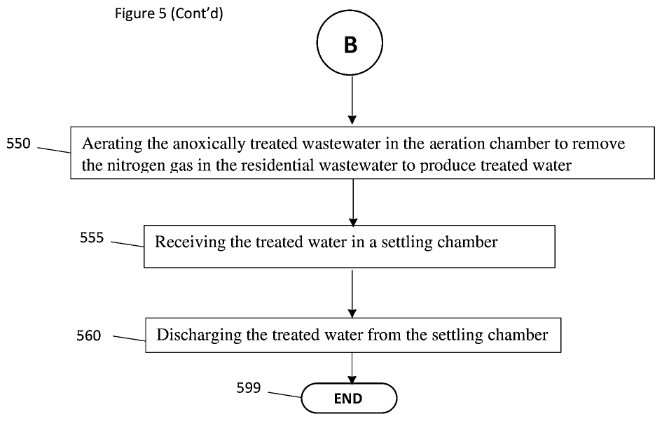

FIG. 5 is a flow chart of another embodiment of a wastewater treatment method 500 of treating wastewater/sewage to remove total nitrogen from an influent residential wastewater flow, in accordance with the disclosed subject matter. While the following embodiment of the method will be described in relation to the specific system 100 shown and described herein, it should be clearly understood that the method can be used in various such systems. In FIG. 5, the wastewater treatment method 500 for removing TN from the influent residential wastewater flow can start (501) by receiving and pre-treating (505) an influent flow of the wastewater/sewage 201 in the pretreatment chamber 110 of the wastewater/sewage treatment unit/apparatus 100. While in the pretreatment chamber 110 the received wastewater/sewage 201 is permitted to settle out some of the floating solids that are present in the received wastewater/sewage 201 to form a pretreated wastewater/sewage 201a. The method 500 can then continue by receiving (510) the pretreated wastewater/sewage 201a from the pretreatment chamber 110 in the anoxic chamber 120. The method 500 can continue by measuring (515) pH and dissolved oxygen levels in the pretreated wastewater/sewage 201a located in the anoxic chamber 120 and in the anoxically treated wastewater/sewage 201b located in the aeration chamber 130 to determine and control the amounts of supplementary materials that should be added to the pretreated wastewater/sewage 201a in the anoxic chamber 120. The method 500 can optionally compare (515) the measured pH and dissolved oxygen levels in the anoxic chamber 120 and the aeration chamber 130 to determine the proper amounts of the supplements that need to be added to the aeration chamber 130. The method 500 can continue by determining (516) whether to optionally include maintaining (517) a minimum temperature of the pretreated wastewater/sewage 201a in the anoxic chamber 110, which control can be based on a measured temperature level of the pretreated wastewater/sewage 201a in the anoxic chamber 120. The temperature control can be automatic based on: predefined historical levels; real time predetermined levels; or timed, based on the time of day, the season, or both.

In FIG. 5, the method 500 can continue by receiving (520) an amount of organic carbon material 305 in the anoxic chamber 110, which can be delivered manually or automatically based on the measured pH of the pretreated wastewater/sewage 201a in the anoxic chamber. In one or more embodiments of the disclosed subject matter, the organic carbon material 305 can be received to maintain a predefined ratio between the organic carbon level and the TN level of the pretreated wastewater/sewage 201a in the anoxic chamber 120. The method 500 can then continue by receiving (525) an amount of an alkaline material in the anoxic chamber, which can be delivered manually or automatically based on the measured pH of the anoxic chamber to maintain a predefined pH and a predefined ratio between the pH and the TN level of the pretreated wastewater/sewage 201a in the anoxic chamber. It is also possible that both the organic carbon material 305 and the alkaline material 310 are delivered together. In general, a ratio of the alkaline material 310 to the organic carbon material 305 added is in a range from 1:2 to 1:7.5, especially when the organic carbon material 305 and the alkaline material 310 are dosed together either manually or automatically. The method 500 can continue by performing (530) a nitrification process and a denitrification process on the residential wastewater in the anoxic chamber to convert ammonium to nitrogen gas and process the pretreated wastewater/sewage 201a into the anoxically treated wastewater/sewage 201b to be passed to the aeration chamber 130. The method 500 can include pumping (532) the sludge 244 back from the settling chamber 140 into the anoxic chamber 120 to be mixed with the pretreated wastewater/sewage 201a. Depending on the measured conditions of the pretreated wastewater/sewage 201a and/or the anoxically treated wastewater/sewage 201b, the method 500 may continue by determining (533) whether to optionally include adding (534) an amount of at least one bacteria 315 to the anoxic chamber 120 based on the measured conditions. In general, if it is determined (533) that bacteria 315 is to be added, it can be added manually or automatically via a feeder system. Further, if needed, and as noted above in relation to FIG. 4, additional chemical and physical treatments can be added to the method 500, depending on the specific characteristics of the wastewater/sewage being treated.

In FIG. 5, the method 500 can continue by receiving (535) the anoxically treated wastewater/sewage 201b from the anoxic chamber 120 in the aeration chamber 130 and measuring (540) pH and dissolved oxygen levels in the anoxically treated wastewater/sewage 201b in the aeration chamber 130. The method 500 can then continue by receiving (545) a second amount of the alkaline material 310′ in the aeration chamber 130 to maintain a predefined pH and a predefined ratio between the pH and the TN level of the anoxically treated wastewater/sewage 201b in the aeration chamber. The second amount of the alkaline material 310′ can be provided based on the measured pH of the aeration chamber and either manually or automatically The method 500 can then continue by aerating (550) the anoxically treated wastewater/sewage 201b in the aeration chamber 130 to remove the nitrogen gas from the anoxically treated wastewater/sewage 201b to produce treated water 201c. The aerating (550) can be accomplished by using the air pump 136 to pump air 235 down the air pump pipe 137 and out through the air diffuser 133 and into the aeration chamber 130 to mix the air 235 with the anoxically treated wastewater/sewage 201b to produce the treated water 201c. The method 500 can then continue by receiving (555) the treated water 201c in the settling chamber 140 and then discharging (560) the treated water 201c from the settling chamber 140 through the flow equalizer 142 and the settling chamber outlet 144 into the effluent exit pipe 147.

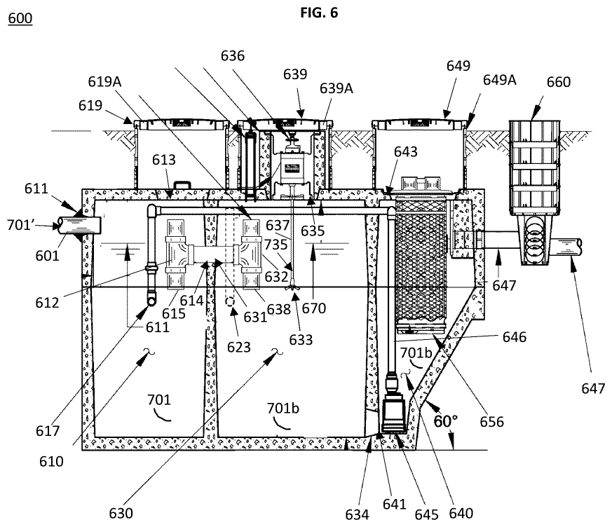

FIG. 6 is a cross-sectional side view of a wastewater treatment system tank with a pretreatment chamber, an aeration chamber, and a settling chamber, in accordance with one or more other embodiments of the disclosed subject matter. In FIG. 6, a wastewater/sewage treatment system unit 600 with a pretreatment chamber 610, an aeration chamber 630, and a settling chamber 640, in accordance with one or more embodiments of the disclosed subject matter. The pretreatment chamber 610 includes a pretreatment chamber inlet 611 with an influent pipe 601 through which the wastewater enters the pretreatment chamber 610 and a pretreatment chamber transfer tee 612 positioned in a pretreatment chamber outlet pipe 614 through which the wastewater exits the pretreatment chamber 610 and enters the aeration chamber 630. An invert of the pretreatment chamber inlet 611 is at a height that is above a top of the pretreatment chamber outlet pipe 614 to help encourage the flow of the wastewater/sewage through the pretreatment chamber 610 toward the settling chamber 640 and to prevent or reduce backflow of the contents of the pretreatment chamber 610 back into the influent pipe 601. The pretreatment chamber 610 also includes an access opening 613 in a top of the pretreatment chamber 610, which provides physical access to an interior of the pretreatment chamber 610 and to the transfer tee 612. As seen in FIG. 6, the pretreatment chamber 610 can include a mixing bar 617 that is in a one-way fluid communication with a sludge return pump 645 located in the settling chamber 640. The mixing bar 617 can be positioned above a middle of the pretreatment chamber 610 and below an bottom 615 of the pretreatment chamber transfer tee 612 and the pretreatment chamber mixing bar 617 is in the one-way fluid communication with the settling chamber 640 via a sludge return pipe system 646 to receive settled sludge pumped by a sludge return pump 645 from the settling chamber 640. In the pretreatment chamber 610, the incoming influent wastewater/sewage can be treated with a substance to promote settling of the colloidal particles suspended in the wastewater/sewage, including, for example, a flocculant including, but not limited to, an alum, such as (Al₂(SO₄)₃·14H₂O), to encourage and allow the suspended solids in the wastewater/sewage to come out of suspension and drop to the bottom of the pretreatment chamber 610 and allow clearer wastewater/sewage, i.e., wastewater/sewage with a lower concentration of solids suspended in the wastewater/sewage than in the original influent, to flow up through an bottom of the transfer tee 612, then through the pretreatment chamber outlet 614 and an aeration chamber inlet 631, and out an bottom 638 of an aeration chamber inlet transfer tee 632 that are in fluid communication with each other and into the aeration chamber 630.

In FIG. 6, the aeration chamber 630 also includes an aeration chamber outlet 634 that is in fluid communication with the settling chamber 640 via a settling chamber inlet 641. The aeration chamber 630 also includes an aeration chamber access opening 635 in a top of the aeration chamber 630, and the aeration chamber access opening 635 provides physical access to an interior of the aeration chamber 630 through an aeration chamber riser 639. The aeration chamber riser 639 generally is sealingly affixed around the aeration chamber access opening 635 and includes an aeration chamber riser lid 639a to permit access to the aeration chamber 630. Alternatively, instead of the pretreatment chamber mixing bar 617 being located in the pretreatment chamber 610, an aeration chamber mixing bar 623 can be located in the aeration chamber 630 and similarly the mixing bar 623 can be positioned above a middle of the aeration chamber 630 and below the bottom of the aeration chamber inlet transfer tee 632 and the mixing bar 623 is in one-way fluid communication with the settling chamber 640 via a sludge return pipe system 646 to receive settled sludge pumped by a sludge return pump 645 from the settling chamber 640. In some embodiments of the presently disclosed subject matter, one or more separate or combined aeration supplement dispensers, i.e., supplement dispensing units, (not shown) can be located in the aeration chamber riser 639 and be in fluid communication with the aeration chamber 630 through the aeration chamber access opening 635. The dispensers can be a single supplement dispenser that can provide a single supplement or a multiple supplement dispenser that can provide two or more supplements either separately from separate compartments or together from a single compartment. In addition, if the two or more supplements are provided separately from separate compartments, they can also be provided at different times.

In FIG. 6, the aeration chamber inlet 631 is in fluid communication with the pretreatment chamber 610 via the aeration chamber transfer tee 632, which opens downwardly into the aeration chamber 630, to receive the pretreated wastewater/sewage from the pretreatment chamber 610. The aeration chamber 630 includes an aeration chamber outlet 634 that is in fluid communication with the settling chamber 640 via a settling chamber inlet 641 to permit the aerated wastewater/sewage to flow into the settling chamber 640. The aeration chamber 630 further includes an aerator 636, for example, but not limited to, a Singulair Aerator from Norweco Equipment Company of Norwalk, Ohio, including and in fluid communication with an air diffuser aspirator tip 633 that is positioned generally adjacent to and just below a top level 670 of the water in the aeration chamber 630 and that is in fluid communication with an aerator 636, which can be in an aeration chamber riser 639, via an aspirator shaft 637 to permit air to be introduced into and to aerate the wastewater/sewage in the aeration chamber 630. The aeration chamber 630 also includes an aeration chamber access opening 635 in a top of the aeration chamber 630, and the aeration chamber access opening 635 provides physical access to an interior of the aeration chamber 630 through the aeration chamber riser 639. The aeration chamber riser 639 generally is sealingly affixed around the aeration chamber access opening 635 to prevent the passage of liquids or solids into or out of the aeration chamber 630. The aeration chamber riser 639 also includes an aeration chamber riser lid 639a to permit access to the aerator 636 and the aeration chamber 630. In some embodiments of the presently disclosed subject matter, one or more separate or combined aeration supplement dispensers, i.e., supplement dispensing units, (not shown) can be located in the aeration chamber riser 639 as well as the pretreatment chamber riser 619 and in fluid communication with the aeration chamber 630 through the aeration chamber access opening 635 and the pretreatment chamber 610 through the pretreatment chamber access opening 613. The dispensers can be a single supplement dispenser that can provide a single supplement or a multiple supplement dispenser that can provide two or more supplements either separately from separate compartments or together from a single compartment. In addition, if the two or more supplements are provided separately from separate compartments, they can also be provided at different times.

In FIG. 6, the settling chamber inlet 641 is in fluid communication with the aeration chamber 630 via the aeration chamber outlet 634 and the settling chamber 640 further includes a flow equalizer 642 positioned inside a bioreactor 656 that is connected to and in fluid communication with a settling chamber outlet 644 through which the treated wastewater/sewage exits the settling chamber 640 through an effluent exit pipe 647. The settling chamber 640 also includes a settling chamber access opening 643 in a top of the settling chamber 640, and the settling chamber access opening 643 provides physical access to an interior of the settling chamber 640 through a settling chamber riser 649. The settling chamber riser 649 generally is sealingly affixed around the settling chamber access opening 643 to prevent the passage of liquids or solids into or out of the settling chamber 640. The settling chamber riser 649 also includes an aeration chamber riser lid 649a to permit access to a clean-out 648 of the sludge return pipe system 646, the flow equalizer 642, and the settling chamber 640. The bioreactor 656 can include, for example, but not be limited to, an ultraviolet (UV) or membrane bioreactor 656, such as, for example, but not limited to, a Bio-Kinetic© system as provided by Norweco Equipment Company of Norwalk, Ohio, as a final treatment step in the process of treating the wastewater/sewage.

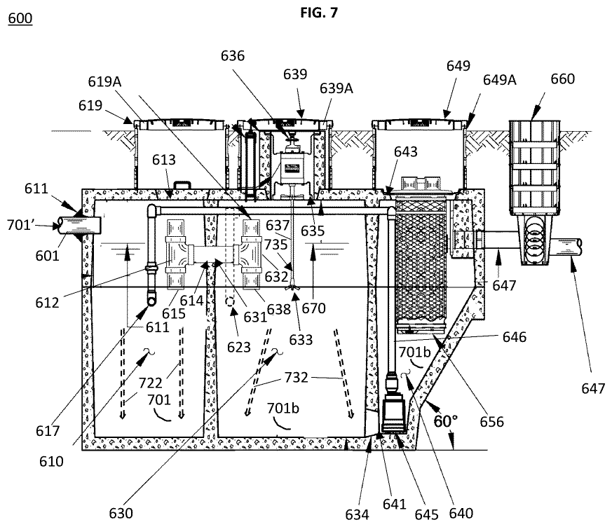

FIG. 7 is a cross-sectional, side view of the wastewater treatment system tank of FIG. 6 showing the flow pattern of the effluent water through the chambers in the wastewater treatment system tank, in accordance with one or more embodiments of the disclosed subject matter. In FIG. 7, the influent wastewater/sewage 701 enters into the pretreatment chamber 710 through the pretreatment chamber inlet 711 where it has time for a portion of the floating solids to settle to the bottom of the pretreatment chamber 710 to produce a pretreated wastewater/sewage 701. When a level 711 of the pretreated wastewater/sewage 701 in the pretreatment chamber 610 rises up through an invert 712 of the pretreatment transfer tee 612 and to a height above the bottom of the pretreatment chamber outlet 612, it can flow through the pretreatment chamber outlet 612 and the aeration chamber inlet 631 into the aeration chamber 630. The sludge return pump 645 can pump sludge 744 that has settled at the bottom of the settling chamber 640 up through the sludge return pipe system 646 and back to the mixing bar 623 that is positioned near the middle of the pretreatment chamber 610. When the sludge 244 reaches the mixing bar 623 it passes out through multiple openings that are formed through the mixing bar 623 and into the aeration chamber 630 to create a downwardly rolling flow 722 of the sludge to mix into the wastewater/sewage within the pretreatment chamber 610. As the level 711 of the pretreated wastewater/sewage 701 in the pretreatment chamber 610 rises to a height above the bottom of the pretreatment chamber outlet 614, it flows through the aeration chamber inlet 631, and the aeration chamber transfer elbow 632 into the aeration chamber 630. Air 735 from the air pump 636 is forced down the air pump pipe 637 into the air diffuser 633 and out through the air diffuser aspirator tip 633 and into the aeration chamber 630 to create a downward flow 732 of the air 735 toward a top level 721 of the pretreated wastewater/sewage 701b within the aeration chamber 630 to produce an aerated wastewater/sewage 701b.

In FIG. 7, the aeration chamber outlet 634 is located at the bottom of the aeration chamber 630 and is in fluid communication with the settling chamber inlet 641 to permit the aerated wastewater/sewage 701b to flow from the aeration chamber 630 into the settling chamber 640 through the aeration chamber outlet 634 and a settling chamber inlet 645 located at a bottom of each chamber. A bottom portion of the settling chamber 640 is angled downwardly and inwardly on the three sides not connected to the aeration chamber 630 to form an angled funnel or hopper shape to direct the sludge 744 as it settles to the bottom of the settling chamber 140 toward the sludge return pump 645. As the level of the aerated wastewater/sewage 701b in the settling chamber 640 rises up, it encounters and can pass through the bioreactor 656 to further treat the aerated wastewater/sewage 701b and produce a treated wastewater 701c that continues to rise up and into the flow equalizer 642. When the treated wastewater 701c reaches a height above the bottom of the settling chamber outlet 644, it flows through the settling chamber outlet 644 to the effluent exit pipe 647 and out of 750 the settling chamber 640.

In FIG. 7, as required, the sludge pump can be turned on and the sludge 744 that has settled to the bottom of the settling chamber 640 can be pumped via the sludge return pipe 646 back to and through the mixing bar 623 and into and mixed with the wastewater in the aeration chamber 630.

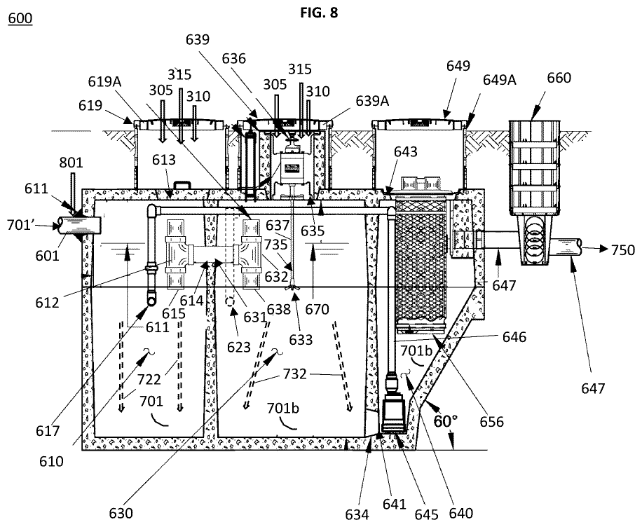

FIG. 8 is a cross-sectional side view of the wastewater treatment system tank of FIG. 6 showing the method of dosing the supplements, in accordance with one or more embodiments of the disclosed subject matter. As shown in FIG. 8, a urea solution 801 can be dosed into the influent wastewater/sewage 701 as it enters the pretreatment chamber 610 to increase TN in the influent wastewater/sewage 701 for the testing, and two supplement materials, an organic material (i.e., granular sugar) 805 and an alkalinity material (i.e., Sodium Bisulfate tablets) 810 were added into the aeration chamber 630, in the form of the combined supplement solution described above. While these were the two supplement materials used for these tests, the performance of the method of the disclosed subject matter is not limited to only the use of these two materials nor are they limited to the form in which the materials were used for the tests. For example, the organic material 805 could also include, but is not limited to, sugar, methanol, ethanol, acetic acid, acetate, and glycerol; and the alkalinity material 810 could include, but is not limited to, sodium carbonate, magnesium hydroxide, and sodium bicarbonate. During the tests, the two supplements were automatically dosed or manually added into the aeration chamber 630 on a daily basis. The alkalinity material 810 was added to maintain the wastewater/sewage alkalinity between 100 and 250 ppm. In the various embodiments, these two supplements can be added separately or together either manually or using one or more specially designed dosing or dispensing apparatus or devices. In addition, the dosing of the organic and alkaline supplements can be for varying amounts and performed on preset timed intervals, e.g., but not limited to, morning, dinner, or on predetermined regular time intervals such as intervals measured in minutes or hours. The alkalinity material 810 and organic material 805 can be made as a powder, a granular, a pillar, or a tablet shape, or in a liquid depending upon dosing requirements of an apparatus or a device. In one embodiment, where the two supplements can be added separately, the organic material 805 can be added at or adjacent to the aeration chamber inlet 631 and the alkalinity material 810 can be added at or adjacent to the aeration chamber outlet 632. In general, when added separately, a 1:1 ratio of organic to alkaline supplements was used. In another embodiment, where the two supplements can be added together, they can be added to the aeration chamber 630, for example, but not limited to, near the aeration chamber inlet 631. In general, when the supplements are added together, in a range from 2:1 to 7.5:1 ratio of organic to alkaline supplements was used. A DO meter can be used to assist in the dosing of the supplements, by measuring the dissolved oxygen content in the wastewater/sewage in the aeration chamber 630 and in the pretreatment chamber 610. In addition, the pH levels in both the aeration chamber 630 and in the pretreatment chamber 610 were measured to aid in determining the amounts to dose of each supplement. The system and method can be implemented with combined or separate dispensers of the supplements, for example, in the aeration chamber 630, there can be separate dispensers for the organic carbon material 805 and the alkaline material 810 or a single dispenser in which both the organic carbon material 805 and the alkaline material 810 can be premixed, or loaded into separate compartments, and provided in a predefined ratio to each other from separate compartments of the single dispenser. In some embodiments of the pretreatment chamber 610, another single dispenser for the alkaline material 810 can be implemented in the pretreatment chamber 610 and which can be located in the aeration chamber riser 639.

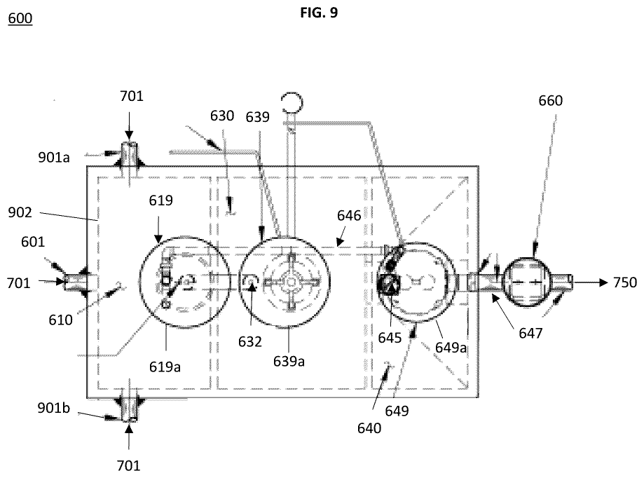

FIG. 9 is a top plan view of the wastewater treatment system tank of FIG. 6, in accordance with one or more embodiments of the disclosed subject matter. In FIG. 9, a top 902 of the wastewater treatment system 600 is shown to illustrate the positioning of the pretreatment chamber riser 619, the aeration chamber riser 639, and the settling chamber riser 649. Although shown in FIG. 6 as being substantially in line with the inlet line 601 and the outlet line 647, they are not required to be, but should provide access to the outlet tee 612 of the pretreatment chamber 610, the inlet tee 632 of the aeration chamber, the sludge return mixing bar 617, and the aeration equipment 636. As seen in FIG. 9, two alternative inlet lines 901a and 901b are seen on opposite sides of the pretreatment chamber 610 and one or more of them can be used.

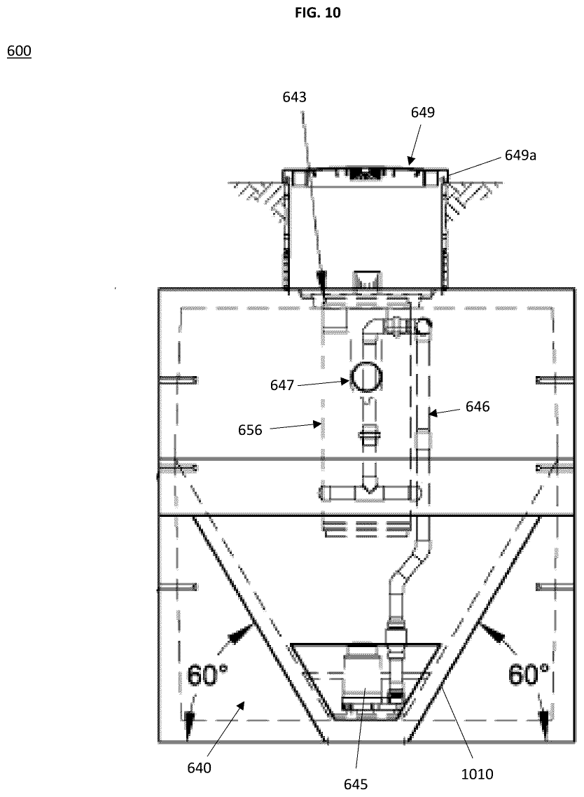

FIG. 10 is an end view of the wastewater treatment system tank of FIG. 6 showing the end of the settling chamber 640, in accordance with one or more embodiments of the disclosed subject matter. In FIG. 10, the angled, hopper-shaped bottom portion 1010 of the settling chamber 640 is shown, which helps direct the settling sludge in the settling chamber 640 to collect in a small area adjacent to the sludge pump 645, so the sludge can be pumped back to the aeration chamber 630, or in some embodiments, it could alternative or additionally be pumped back to the pretreatment chamber 610.

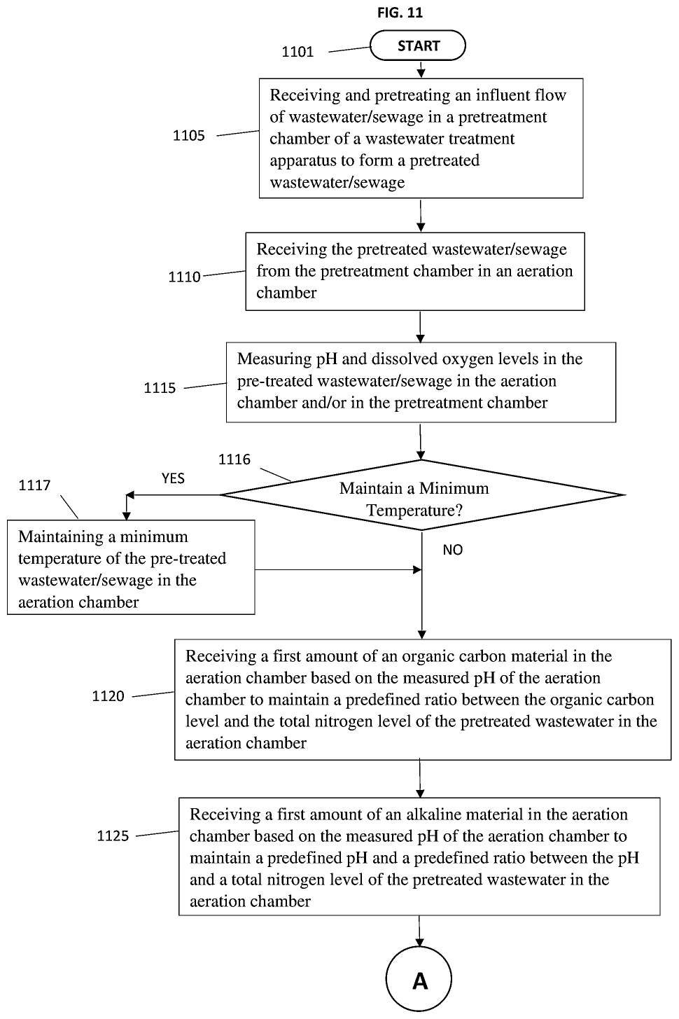

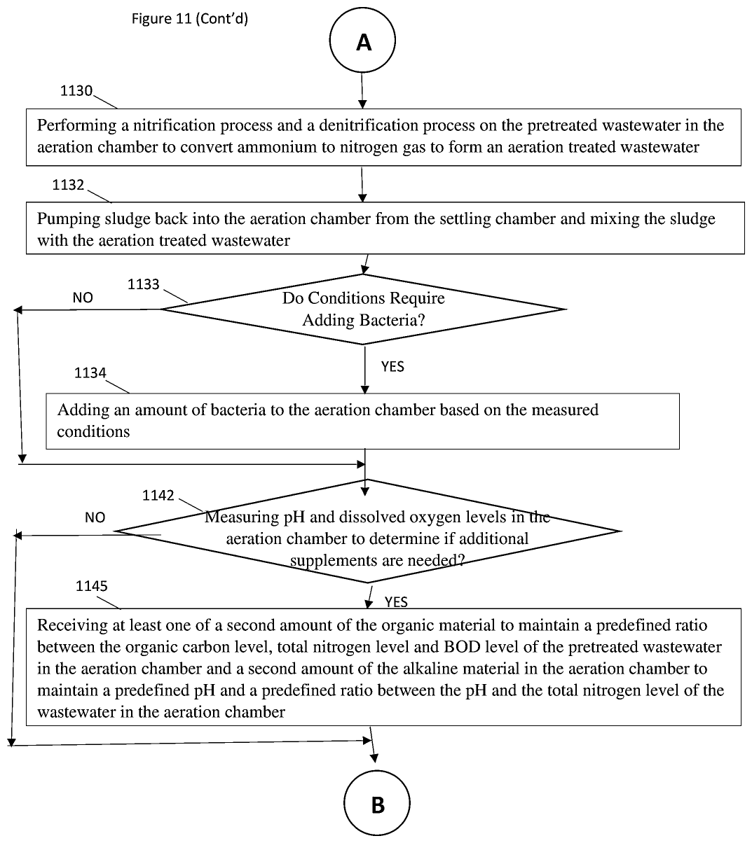

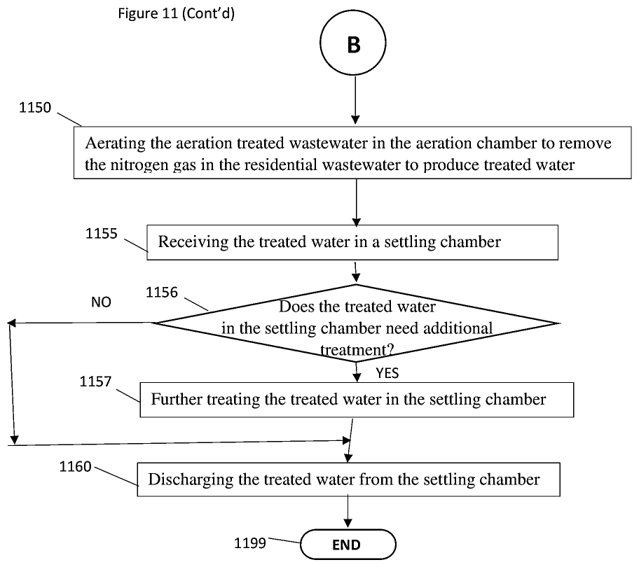

FIG. 11 is a flow chart of an embodiment of a wastewater treatment method 1100 of treating wastewater/sewage to remove total nitrogen from an influent residential wastewater flow, in accordance with the disclosed subject matter. While the following embodiment of the method will be described in relation to the specific system 600 shown and described herein, it should be clearly understood that the method can be used in various such systems. In FIG. 11, the wastewater treatment method 1100 for removing TN from the influent residential wastewater flow can start (1101) by receiving and pre-treating (1105) an influent flow of the wastewater/sewage 701 in the pretreatment chamber 610 of the wastewater/sewage treatment unit/apparatus 600. While in the pretreatment chamber 610 the received wastewater/sewage 701 is permitted to settle out some of the floating solids that are present in the received wastewater/sewage 701 to form a pretreated wastewater/sewage 701a. To aid in raising the TN levels for the testing, the pretreatment chamber 610 received a urea 801 supplement, but the addition of the urea 801 is not part of the normal operation of the system. The method 1100 can then continue by receiving (1110) the pretreated wastewater/sewage 701a from the pretreatment chamber 610 in the aeration chamber 630. The method 1100 can continue by measuring (415) pH and dissolved oxygen levels in the pretreated wastewater/sewage 701a located in the aeration chamber 630 and in the wastewater/sewage 701 located in the pretreatment chamber 610 to determine and control the amounts of supplementary materials that should be added to the pretreated wastewater/sewage 701a in the aeration chamber 630. The method 1100 can optionally compare (1115) the measured pH and dissolved oxygen levels in the aeration chamber 630 and the pretreatment chamber 610 to determine the proper amount of the supplements that need to be added to the aeration chamber 630. The method 1100 can continue by determining (1116) whether to optionally include maintaining (1117) a minimum temperature of the pretreated wastewater/sewage 701a in the aeration chamber 630, which control can be based on a measured temperature level of the pretreated wastewater/sewage 701a in the aeration chamber 630. The temperature control can be automatic based on predefined historical levels; real time predetermined levels; or timed, based on the time of day, the season, or both.

In FIG. 11, the method 1100 can continue by receiving (1120) an amount of organic carbon material 805 in the aeration chamber 630. This organic carbon material 805 can be delivered manually or automatically by, for example, but not limited to, a first dispenser based on the measured pH of the pretreated wastewater/sewage 701a in the aeration chamber 630. In one or more embodiments of the disclosed subject matter, the organic carbon material 805 can be added adjacent to the aeration chamber inlet 631 to maintain a predefined ratio between the organic carbon level and the TN level of the pretreated wastewater/sewage 701a in the aeration chamber 630. The method 1100 can then continue by receiving (1125) an amount of an alkaline material 810 in the aeration chamber 630. The alkaline material 810 can be delivered manually or automatically by, for example, but not limited to, a second dispenser based on the measured pH of the aeration chamber and delivered adjacent to an outlet of the aeration chamber to maintain a predefined pH and a predefined ratio between the pH and the TN level of the pretreated wastewater/sewage 701b in the aeration chamber. It is also possible that both the organic carbon material 805 and the alkaline material 810 are delivered together, so in this embodiment of the method 1100, both materials could be provided from the first dispenser. In general, a ratio of the organic carbon material 805 to the alkaline material 810 added can be in a range from 2:1 to 7.5:1, especially when the organic carbon material 805 and the alkaline material 810 are dosed together either manually or from a single dispenser. The method 800 can continue by performing (1130) a nitrification process and a denitrification process on the residential wastewater in the aeration chamber 630 to convert ammonium to nitrogen gas and process the pretreated wastewater/sewage 701b into an aerated treated wastewater/sewage 701b to be passed to the settling chamber 640. The method 1100 can include pumping (1132) the sludge 744 back from the settling chamber 640 into the aeration chamber 630 to be mixed with the pretreated wastewater/sewage 701b. Although shown in FIG. 11 as step (1132), it could also be performed after step (1155), which would be most common when the system was first installed and being run for the first time or after being restarted after being repaired and cleared. Depending on the measured conditions of the pretreated wastewater/sewage 701b and/or the aerated treated wastewater/sewage 701b, the method 1100 may continue by determining (1133) whether to optionally include adding (1134) an amount of at least one bacteria 815 to the aeration chamber 630 based on the measured conditions. In general, if it is determined (1133) that a bacteria 815 is to be added, it can be added (1134) manually or automatically via a feeder system. Further, if needed, additional chemical treatments can be added to the method 1100, depending on the specific characteristics of the wastewater/sewage being treated, for example, but not limited to, chemicals to remove phosphates, chemicals for disinfection, microbicides for disinfection, chemicals for de-chlorination, Vitamin C for de-chlorination, and bacteria and enzymes for removing grease, fats, and oils. Similarly, a non-chemical treatment system with Ultraviolet (UV) light for disinfection can be used.

In FIG. 11, the method 1100 can continue by determining (1142) whether the aerated treated wastewater/sewage 701b in the aeration chamber 630 requires additional supplements by measuring pH and dissolved oxygen levels in the aerated treated wastewater/sewage 701b in the aeration chamber 630. If it is determined (1142) that additional supplements are needed, then the method 1100 can continue by receiving (1145), a second amount of the organic material 805′ and/or alkaline material 810′ can be added to the aeration chamber 630 to maintain a predefined pH and a predefined ratio between the pH and the TN level of the aerated treated wastewater/sewage 701b in the aeration chamber. The second amount of the supplements can be provided based on the measured pH of the aeration chamber and provided either manually or from the second dispenser or a third dispenser, depending on whether the first & second dispensers used in the aeration chamber 630 are separate or combined. The method 1100 can then continue by further aerating (1150) the pretreated wastewater/sewage 701b in the aeration chamber 630 to remove the nitrogen gas from the pretreated wastewater/sewage 701b to produce treated water 701c. The aerating (1150) can be accomplished by using the air pump 636 to pump air 735 down the air pump pipe 637 and out through the air diffuser 633 and into the aeration chamber 630 to mix the air 735 with the pretreated wastewater/sewage 701b to produce the treated water 701c. The method 1100 can then continue by receiving (1155) the treated water 701c in the settling chamber 640 and determining (1156) whether the treated water needs additional treatment before being discharged from the settling chamber 640. If additional treatment is determined (1156) to be needed, the method 1200 can continue by further treating (1157) the treated water by performing additional flow control and filtration of the treated water using, for example, but not limited to, a Bio-Kinetic© system from Norweco Equipment Company of Norwalk, Ohio. As part of the further treating (1157), the method 1100 can use treatments, including, for example, but not limited to, chlorine, dechlorination chemicals, and ultraviolet (UV) light. The method 1100 can continue by discharging (1160) the treated water 701c from the settling chamber 640 through the flow equalizer 642 and the settling chamber outlet 644 into the effluent exit pipe 647.

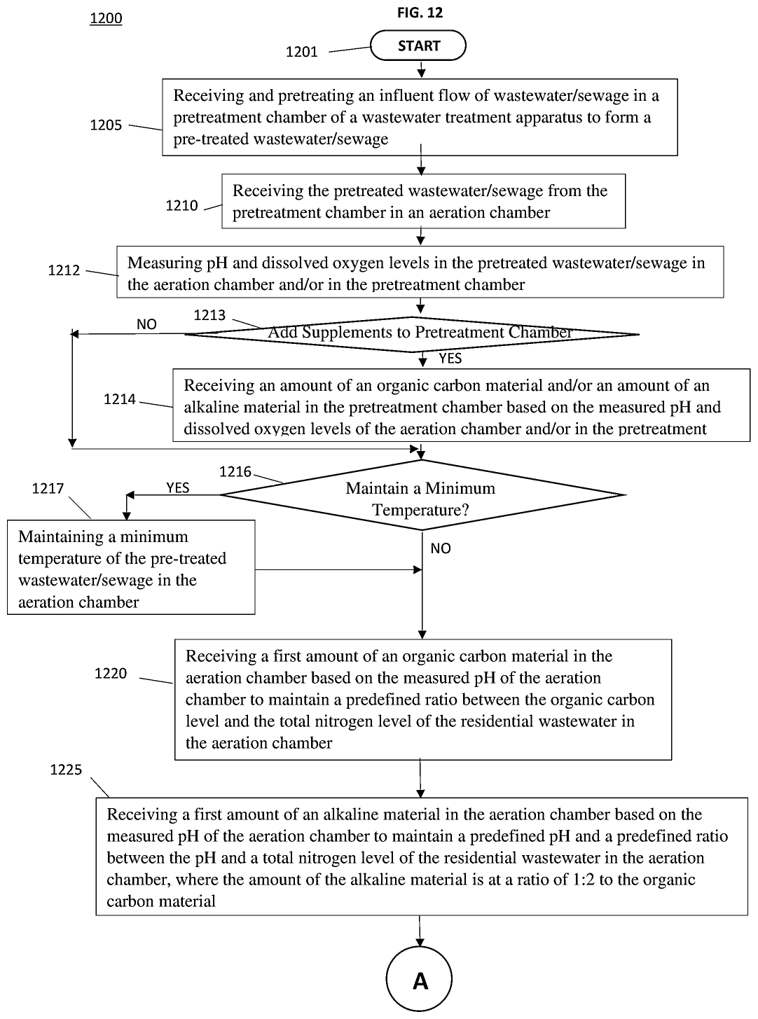

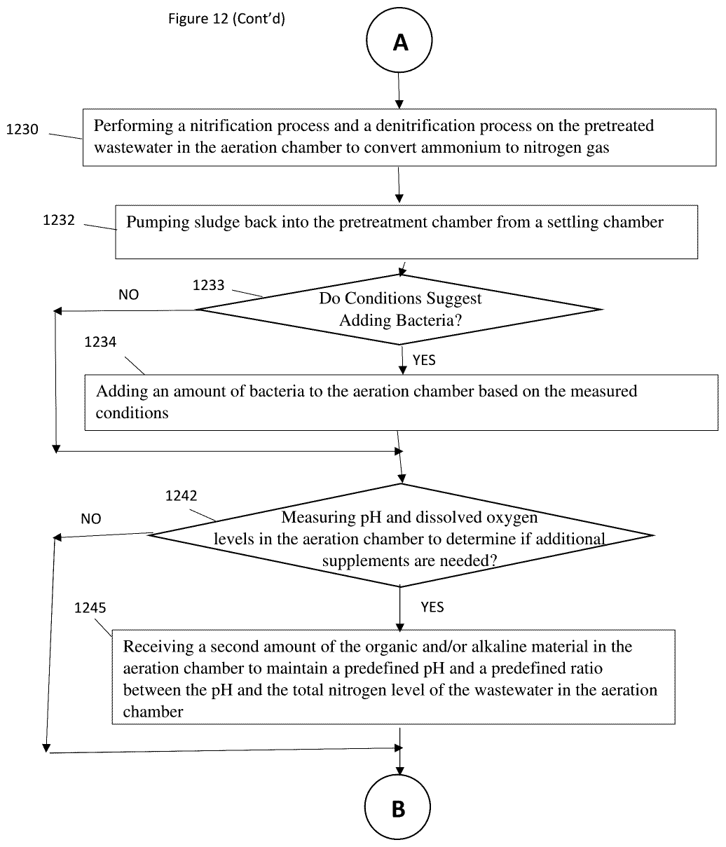

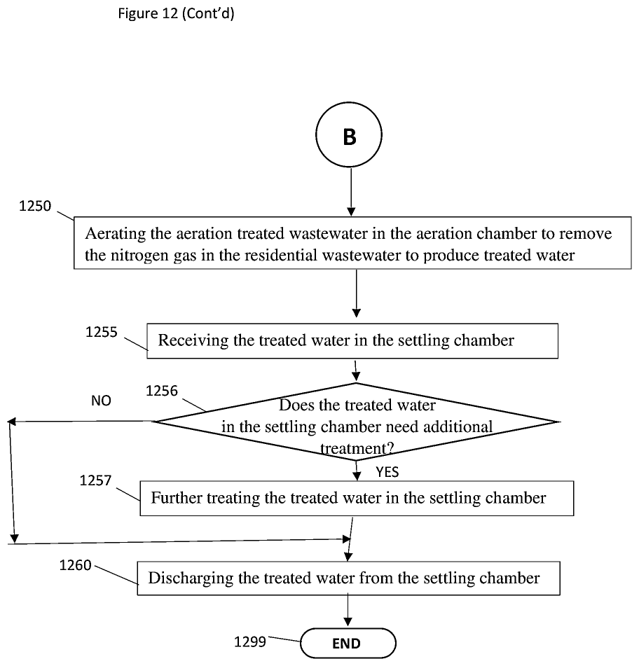

FIG. 12 is a flow chart of another embodiment of a wastewater treatment method 1200 of treating wastewater/sewage to remove total nitrogen from an influent residential wastewater flow, in accordance with the disclosed subject matter. While the following embodiment of the method will be described in relation to the specific system 600 shown and described herein, it should be clearly understood that the method can be used in various such systems. In FIG. 12, the wastewater treatment method 1200 for removing TN from the influent residential wastewater flow can start (1201) by receiving and pre-treating (1205) an influent flow of the wastewater/sewage 701 In the pretreatment chamber 610 of the wastewater/sewage treatment unit/apparatus 600. While in the pretreatment chamber 610 the received wastewater/sewage 701 is permitted to settle out some of the floating solids that are present in the received wastewater/sewage 701 to form a pretreated wastewater/sewage 701b. The method 1200 can then continue by receiving (1210) the pretreated wastewater/sewage 701b from the pretreatment chamber 610 in the aeration chamber 630. The method 1200 can continue by measuring (1212) pH and dissolved oxygen levels in the pretreated wastewater/sewage 701b located in the aeration chamber 630 and in the pretreated wastewater/sewage 701b located in the aeration chamber 630 to determine and control the amounts of supplementary materials that should be added to the pretreated wastewater/sewage 701b in the aeration chamber 630. The method can determine (1213) based on the measured (1212) pH and dissolved oxygen levels in the pretreated wastewater/sewage 701b located in the aeration chamber 630 whether to add supplements, for example, but not limited to, an organic material and an alkaline material to the pretreatment chamber 610. If it is determined (1212) that supplements are needed, the method can include receiving (1214) an amount of the organic material and/or an amount of the alkaline material to the pretreatment chamber 610. As a part of the determining (1212) that supplements are needed, the method 1200 can optionally compare the measured pH and dissolved oxygen levels in the aeration chamber 630 and the pretreatment chamber 610 to determine which of and the proper amounts of the supplements that need to be added to the pretreatment chamber 610. The method 1200 can continue by determining (1216) whether to maintain a minimum temperature in the aeration chamber 630 and if the minimum temperature is to be maintained, maintaining (1217) the minimum temperature of the pretreated wastewater/sewage 701b in the aeration chamber 630, which control can be based on a measured temperature level of the pretreated wastewater/sewage 701b in the aeration chamber 630. The temperature control can be automatic based on predefined historical levels; real time predetermined levels; or timed, based on the time of day, the season, or both.

In FIG. 12, the method 1200 can continue by receiving (1220) an amount of organic carbon material 810 in the aeration chamber 630, which can be delivered manually or automatically based on the measured pH of the pretreated wastewater/sewage 701b in the aeration chamber 630. In one or more embodiments of the disclosed subject matter, the organic carbon material 810 can be received to maintain a predefined ratio between the organic carbon level and the TN level of the pretreated wastewater/sewage 701b in the aeration chamber 630. The method 1200 can then continue by receiving (1225) an amount of an alkaline material in the aeration chamber 630, which can be delivered manually or automatically based on the measured pH of the aeration chamber 630 to maintain a predefined pH and a predefined ratio between the pH and the TN level of the pretreated wastewater/sewage 701b in the aeration chamber 630. It is also possible that both the organic carbon material 805 and the alkaline material 810 are delivered together, either as a mixture or separately. In general, a ratio of the alkaline material 810 to the organic carbon material 805 added is in a range from 1:2 to 1:7.5, especially when the organic carbon material 805 and the alkaline material 810 are dosed together either manually or automatically. The method 1200 can continue by performing (1230) a nitrification process and a denitrification process on the residential wastewater in the aeration chamber 630 to convert ammonium to nitrogen gas and process the pretreated wastewater/sewage 701b into the pretreated wastewater/sewage 701b to be passed to the aeration chamber 630. The method 1200 can include pumping (1232) the sludge 744 back from the settling chamber 640 into the pretreatment chamber 630 to be mixed with the pretreated wastewater/sewage 701b. Although shown in FIG. 12 as step (1232), it could also be performed after step (1255), which would be most common when the system was first installed and being run for the first time or after being restarted after being repaired and cleared. Alternatively, in some embodiments, the sludge can be pumped into the aeration chamber 630. Depending on the measured conditions of the pretreated wastewater/sewage 701b and/or the wastewater/sewage 701 in the pretreatment chamber 610, the method 1200 may continue by determining (1233) whether to optionally include adding (1234) an amount of at least one bacteria 815 to the aeration chamber 630 based on the measured conditions. In general, if it is determined (1233) that bacteria 815 is to be added, it can be added (1234) manually or automatically via a feeder system. Further, if needed, and as noted above in relation to FIG. 8, additional chemical and physical treatments can be added to the method 1200, depending on the specific characteristics of the wastewater/sewage being treated.

In FIG. 12, the method 1200 can continue by measuring (1242) pH and dissolved oxygen levels in the aeration chamber to determine if additional supplements are needed in the aeration chamber 630. If additional supplements are needed, the method 1200 can continue by receiving (1245) a second amount of the organic material 805′ and/or a second amount of the alkaline material 810′ in the aeration chamber 630 to maintain a predefined pH and a predefined ratio between the pH and the TN level of the pretreated wastewater/sewage 701b in the aeration chamber 630. The second amount of the alkaline material 810′ can be provided based on the measured pH of the aeration chamber and either manually or automatically. The method 1200 can then continue by aerating (1250) the pretreated wastewater/sewage 701b in the aeration chamber 630 to remove the nitrogen gas from the pretreated wastewater/sewage 701b to produce treated water 701c. The aerating (1250) can be accomplished by using the air pump 636 to pump air 735 down the air pump pipe 637 and out through the air diffuser 633 and into the aeration chamber 630 to mix the air 735 with the pretreated wastewater/sewage 701b to produce the treated water 701c. The method 1200 can then continue by receiving (1255) the treated water 701c in the settling chamber 640 and determining (1256) whether the treated water needs additional treatment before being discharged from the settling chamber 640. If additional treatment is determined (1256) to be needed, the method 1200 can continue by further treating (1257) the treated water by performing additional flow control and filtration of the treated water using, for example, but not limited to, a Bio-Kinetic© system from Norweco Equipment Company of Norwalk, Ohio. As part of the further treating (1257), the method (1200) can use treatments, including, for example, but not limited to, chlorine, dechlorination chemicals, and ultraviolet (UV) light. The method 1200 can continue by discharging (1260) the treated water 701c from the settling chamber 640 through the flow equalizer 642 and the settling chamber outlet 644 into the effluent exit pipe 647.

### Test Results.

The tests were conducted in 9 test periods. The test results listed in Table 1 shows that the TN removal efficiency can be increased by adding supplements into the treatment plant. The parameters are listed as average with the highest value, or average with the lowest value.
Test period 1 and 2: In these two tests, the influent TN concentration was manually increased from 36 to 60 mg/L. The effluent TN was not affected by increasing the influent TN concentration.
Test Period 3: The influent TN was increased to 88 mg/L, the nitrification and denitrification were affected by high influent TN concentration. The average effluent TN was increased from 17 to 25 mg/L.
Test Period 4: Influent TN concentration was increased to 166 mg/L. The average effluent alkalinity was naturally decreased to 11 mg/L, and the lowest alkalinity was only 3 mg/L. It means that lack of alkalinity affects the nitrification process. The TN concentration in the effluent was as high as 50 mg/L TN in the effluent. Also, it was noted that a high concentration of TN in the system affects the activated sludge settling process in the settling chamber. The average TSS in the effluent was 15 mg/L. The average effluent pH was dropped down with the lowest pH of 5.0. As a result, the nitrification was significantly affected by low pH in the treatment plant.
Test Period 5: After adjusting alkalinity in the system, the effluent TN concentration was still high, which means that the organic carbon source in the biological treatment system is not enough to keep the ratio between organic carbon source and TN. Therefore, a certain quantity of an organic carbon source should be added into the treatment plant to improve nitrification and denitrification. The results verify that a high concentration of TN in the system affects the activated sludge settling process in the settling chamber. Because of accumulated high TN problem in the treatment plant, the average TSS in the effluent was still high.
Test Period 6 to 8: Three different dosage levels were applied to dose a sugar solution into the anoxic chamber for test periods 6 to 8. The sugar dosage was gradually increased from period 6 through 8. It is clear that by adding an adequate organic carbon source and alkalinity helps to remove more TN in the treatment system. In test period 8, more sugar was added to the treatment plant than in test periods 6 and 7. The dosage in test period 8 was close to keeping the ratio in balance. The average TN concentration was decreased from 163 to 14 mg/L through the treatment plant. Also, the effluent CBOD₅ and TSS were low enough to meet any discharge limits in the US.
Test Period 9: In order to dose sugar in an easy manner, dry sugar at level 4 was added into the anoxic chamber instead of dosing the liquid sugar solution. Compared to test period 8, 48% more sugar was added into the anoxic chamber in this test period. The treatment results from test period 9 are very close to the results obtained from test period 8. It means that over dosage of sugar to the system does not help to remove more TN. In the test 8, the level 3 sugar dosage is an appropriate point to treat 160 ppm TN.

TABLE 1
Removing High TN Concentration with Supplements Method (HK System at 200 GPD)

| | | | Effluent (mg/L) | | | | |
|---|---|---|---|---|---|---|---|
| | | Influent | | Alkalinity as | | | |
| Test | | TN | TN | CaCO₃ | pH | CBOD5 | TSS |
| Period | Supplements | (mg/L) | (Avg/Highest) | (Avg/Lowest) | (Avg/Lowest) | (Avg/Highest) | (Avg/Highest) |
| 1 | No | 36 | 17/23 | | 7.6/7.5 | 12/22 | 9/18 |
| 2 | Supplements | 60 | 17/23 | | 7.6/7.5 | 4/7 | 5/11 |
| 3 | | 88 | 25/45 | | 7.3/7.2 | 4/5 | 3/4 |
| 4 | | 166 | 50/75 | 11/3 | 6.8/5.0 | 8/14 | 15/59 |
| 5 | Alkalinity | 168 | 62/73 | 123/98 | 7.2/7.2 | 6/7 | 22/31 |
| 6 | Sugar | 160 | 35/40 | 233/166 | 7.5/7.4 | 7/19 | 18/49 |
| | Level-1 | | | | | | |
| | (Solution) + | | | | | | |
| | Alkalinity | | | | | | |
| 7 | Sugar | 172 | 25/34 | 159/144 | 7.3/6.9 | 3/5 | 7/7 |
| | Level-2 | | | | | | |
| | (Solution) + | | | | | | |
| | Alkalinity | | | | | | |
| 8 | Sugar | 163 | 14/16 | 166/132 | 7.3/7.1 | 2/3 | 3/4 |
| | Level-3 | | | | | | |
| | (Solution) + | | | | | | |
| | Alkalinity | | | | | | |
| 9 | Sugar | 158 | 14/19 | 161/130 | 7.3/7.3 | 3/8 | 3/3 |
| | Level-4 | | | | | | |
| | (dry) + | | | | | | |
| | Alkalinity | | | | | | |

In actual field applications, one type of sewage is different from other types of sewage. As a result, characteristics of sewage vary significantly. In any case, adding of supplements to a treatment plant helps to remove more TN, especially if the influent TN is over 70 mg/L.

In one embodiment, a wastewater treatment method for removing total nitrogen from an influent residential wastewater including: receiving an influent flow of a residential wastewater in a pretreatment chamber of a wastewater treatment apparatus; pretreating the residential wastewater in the pretreatment chamber to produce a pretreated wastewater; receiving the pretreated wastewater from the pretreatment chamber in an anoxic chamber; measuring pH and dissolved oxygen levels in the pretreated wastewater in the anoxic chamber and in wastewater in an aeration chamber; receiving a first amount of an organic carbon material in the anoxic chamber to maintain a predefined ratio between the organic carbon level, total nitrogen level and BOD level of the pretreated wastewater in the anoxic chamber; receiving a first amount of an alkaline material in the anoxic chamber to maintain a predefined pH and a predefined ratio between the alkalinity and a total nitrogen level of the residential wastewater in the anoxic chamber; performing a nitrification process and a denitrification process on the pretreated wastewater in the anoxic chamber to convert ammonium to nitrogen gas to form an anoxically treated wastewater; pumping sludge into the pretreatment chamber and mixing the sludge with the pretreated treated wastewater in the pretreatment chamber; receiving the anoxically treated wastewater from the anoxic chamber in an aeration chamber; measuring pH and dissolved oxygen levels in the anoxically treated wastewater in the aeration chamber; receiving at least one of a second amount of the organic material to maintain a predefined ratio between the organic carbon level, total nitrogen level and BOD level of the pretreated wastewater in the aeration chamber and a second amount of the alkaline material in the aeration chamber to maintain a predefined pH and a predefined ratio between the alkalinity and the total nitrogen level of the anoxically treated wastewater in the aeration chamber; aerating the anoxically treated wastewater in the aeration chamber to remove the nitrogen gas in the anoxically treated wastewater to produce treated water; receiving the treated water in a settling chamber; and discharging the treated water from the settling chamber

In one embodiment, a wastewater treatment method for removing total nitrogen from an influent residential wastewater including: receiving and pretreating an influent flow of a residential wastewater in a pretreatment chamber of a wastewater treatment apparatus to produce a pretreated wastewater; receiving the pretreated wastewater from the pretreatment chamber in an anoxic chamber; maintaining a minimum temperature of the pretreated wastewater in the anoxic chamber; measuring pH and dissolved oxygen levels in the pretreated wastewater in the anoxic chamber and an aeration chamber; receiving an organic carbon material in the anoxic chamber adjacent to the inlet of the anoxic chamber from a first dispenser based on the measured pH of the anoxic chamber to maintain a predefined ratio between the organic carbon level and the total nitrogen level of the pretreated wastewater in the anoxic chamber; receiving a first amount of an alkaline material in the anoxic chamber adjacent to an outlet of the anoxic chamber from a second dispenser based on the measured pH of the anoxic chamber to maintain a predefined pH and a predefined ratio between the pH and a total nitrogen level of the pretreated wastewater in the anoxic chamber; performing a nitrification process and a denitrification process on the pretreated wastewater in the anoxic chamber to convert ammonium to nitrogen gas by adding at least one bacteria to the anoxic chamber to create anoxically treated wastewater; receiving the anoxically treated wastewater from the anoxic chamber in the aeration chamber; measuring pH and dissolved oxygen levels in the anoxically treated wastewater in an aeration chamber; receiving at least one of a second amount of the organic material to maintain the predefined ratio between the organic carbon level, total nitrogen level and BOD level of the pretreated wastewater in the aeration chamber and a second amount of the alkaline material in the aeration chamber from a third dispenser, based on the measured pH of the aeration chamber to maintain a the predefined pH and a predefined ratio between the pH and the total nitrogen level of the anoxically treated wastewater in the aeration chamber; aerating the anoxically treated wastewater in the aeration chamber to remove the nitrogen gas in the residential wastewater to produce treated wastewater; receiving the treated wastewater in a settling chamber; returning sludge from the settling chamber to the anoxic chamber; and discharging the treated wastewater from the settling chamber.

In one embodiment, a wastewater treatment method includes receiving an influent flow of a residential wastewater in a pretreatment chamber of a wastewater treatment apparatus; pretreating the residential wastewater in the pretreatment chamber to produce a pretreated wastewater; receiving the pretreated wastewater from the pretreatment chamber in an anoxic chamber; measuring pH and dissolved oxygen levels in the pretreated wastewater in the anoxic chamber and in wastewater in an aeration chamber; receiving an organic carbon material in the anoxic chamber to maintain a predefined ratio between the organic carbon level and the total nitrogen level of the pretreated wastewater in the anoxic chamber; receiving a first amount of an alkaline material in the anoxic chamber to maintain a predefined pH and a predefined ratio between the pH and a total nitrogen level of the residential wastewater in the anoxic chamber; performing a nitrification process and a denitrification process on the pretreated wastewater in the anoxic chamber to convert ammonium to nitrogen gas to form an anoxically treated wastewater; receiving the anoxically treated wastewater from the anoxic chamber in an aeration chamber; measuring pH and dissolved oxygen levels in the anoxically treated wastewater in the aeration chamber; receiving a second amount of the alkaline material in the aeration chamber to maintain a predefined pH and a predefined ratio between the pH and the total nitrogen level of the anoxically treated wastewater in the aeration chamber; aerating the anoxically treated wastewater in the aeration chamber to remove the nitrogen gas in the anoxically treated wastewater to produce treated water; receiving the treated water in a settling chamber; and discharging the treated water from the settling chamber.

In one embodiment, a wastewater treatment method includes receiving an influent flow of a residential wastewater in a pretreatment chamber of a wastewater treatment apparatus; pretreating the residential wastewater in the pretreatment chamber to produce a pretreated wastewater; receiving the pretreated wastewater from the pretreatment chamber in an anoxic chamber; measuring pH and dissolved oxygen levels in the pretreated wastewater in the anoxic chamber and in wastewater in an aeration chamber; receiving an organic carbon material in the anoxic chamber to maintain a predefined ratio between the organic carbon level and the total nitrogen level of the pretreated wastewater in the anoxic chamber; receiving a first amount of an alkaline material in the anoxic chamber to maintain a predefined pH and a predefined ratio between the pH and a total nitrogen level of the residential wastewater in the anoxic chamber; performing a nitrification process and a denitrification process on the pretreated wastewater in the anoxic chamber to convert ammonium to nitrogen gas to form an anoxically treated wastewater; receiving the anoxically treated wastewater from the anoxic chamber in an aeration chamber; measuring pH and dissolved oxygen levels in the anoxically treated wastewater in the aeration chamber; receiving a second amount of the alkaline material in the aeration chamber to maintain a predefined pH and a predefined ratio between the pH and the total nitrogen level of the anoxically treated wastewater in the aeration chamber; aerating the anoxically treated wastewater in the aeration chamber to remove the nitrogen gas in the anoxically treated wastewater to produce treated water; receiving the treated water in a settling chamber; returning sludge from the settling chamber to the anoxic chamber; and discharging the treated water from the settling chamber.

In one embodiment, a wastewater treatment method includes receiving and pretreating an influent flow of a residential wastewater in a pretreatment chamber of a wastewater treatment apparatus to produce a pretreated wastewater; receiving the pretreated wastewater from the pretreatment chamber in an anoxic chamber; maintaining a minimum temperature of the pretreated wastewater in the anoxic chamber; measuring pH and dissolved oxygen levels in the pretreated wastewater in the anoxic chamber and an aeration chamber; receiving an organic carbon material in the anoxic chamber adjacent to the inlet of the anoxic chamber from a first dispenser based on the measured pH of the anoxic chamber to maintain a predefined ratio between the organic carbon level and the total nitrogen level of the pretreated wastewater in the anoxic chamber; receiving a first amount of an alkaline material in the anoxic chamber adjacent to an outlet of the anoxic chamber from a second dispenser based on the measured pH of the anoxic chamber to maintain a predefined pH and a predefined ratio between the pH and a total nitrogen level of the pretreated wastewater in the anoxic chamber; performing a nitrification process and a denitrification process on the pretreated wastewater in the anoxic chamber to convert ammonium to nitrogen gas by adding at least one bacteria to the anoxic chamber to create anoxically treated wastewater; receiving the anoxically treated wastewater from the anoxic chamber in the aeration chamber; measuring pH and dissolved oxygen levels in the anoxically treated wastewater in an aeration chamber; receiving a second amount of the alkaline material in the aeration chamber from a third dispenser, based on the measured pH of the aeration chamber to maintain a predefined pH and a predefined ratio between the pH and the total nitrogen level of the anoxically treated wastewater in the aeration chamber; aerating the anoxically treated wastewater in the aeration chamber to remove the nitrogen gas in the residential wastewater to produce treated wastewater; receiving the treated wastewater in a settling chamber; returning sludge from the settling chamber to the anoxic chamber; and discharging the treated wastewater from the settling chamber.

In one embodiment, a wastewater treatment method includes receiving and pretreating an influent flow of a residential wastewater in a pretreatment chamber of a wastewater treatment apparatus; receiving the pretreated wastewater from the pretreatment chamber in an anoxic chamber; maintaining a minimum temperature of the pretreated wastewater in the anoxic chamber; measuring pH and dissolved oxygen levels in the pretreated wastewater in the anoxic chamber and an aeration chamber; receiving an organic carbon material in the anoxic chamber from a first dispenser based on the measured pH of the anoxic chamber adjacent to the inlet of the anoxic chamber to maintain a predefined ratio between the organic carbon level and the total nitrogen level of the pretreated wastewater in the anoxic chamber; receiving a first amount of an alkaline material in the anoxic chamber from a second dispenser based on the measured pH of the anoxic chamber adjacent to an outlet of the anoxic chamber to maintain a predefined pH and a predefined ratio between the pH and a total nitrogen level of the pretreated wastewater in the anoxic chamber; performing a nitrification process and a denitrification process on the pretreated wastewater in the anoxic chamber to convert ammonium to nitrogen gas by adding at least one bacteria 315 to the anoxic chamber to create anoxically treated wastewater; receiving the anoxically treated wastewater from the anoxic chamber in the aeration chamber; measuring pH and dissolved oxygen levels in the anoxically treated wastewater in an aeration chamber; receiving a second amount of the alkaline material in the aeration chamber from a third dispenser, based on the measured pH of the aeration chamber to maintain a predefined pH and a predefined ratio between the pH and the total nitrogen level of the anoxically treated wastewater in the aeration chamber; aerating the anoxically treated wastewater in the aeration chamber to remove the nitrogen gas in the residential wastewater to produce treated wastewater; receiving the treated wastewater in a settling chamber; returning sludge from the settling chamber to the anoxic chamber; and discharging the treated wastewater from the settling chamber.

In one embodiment, a wastewater treatment plant includes means for receiving a volume of wastewater; means for pretreating the volume of wastewater to produce pretreated wastewater; means for receiving the pretreated wastewater from the pretreating means; means for anoxically treating the pretreated wastewater to produce anoxically treated wastewater; means for delivering an amount of an organic material and a first amount of an alkaline material in the anoxically treating means; means for maintaining a minimum temperature of the pretreated wastewater in the anoxically treating means; means for receiving the anoxically treated wastewater from the anoxically treating means; means for aerating the anoxically treated wastewater to produce aerated wastewater; means for measuring pH and dissolved oxygen levels of the pretreated wastewater in the anoxically treating means and in the anoxically treated wastewater in the aerating means; means for delivering a second amount of the alkaline material in the aerating means; means for receiving aerated wastewater from the aerating means; means for settling the aerated wastewater to produce settled wastewater; means for internally pumping sedimentation and settled wastewater from the settling means back to the anoxically treating means; means for mixing the pumped sedimentation and settled wastewater with the pretreated wastewater in the anoxically treating means; means for treating the settled wastewater to produce treated water; and means for discharging the treated wastewater as an effluent wastewater from the settling means.

In one embodiment, a wastewater treatment plant includes means for receiving a volume of wastewater; means for pretreating the wastewater; means for receiving the pretreated wastewater from the pretreating means; means for anoxically treating the treated wastewater; means for receiving the anoxically treated wastewater from the anoxically treating means; means for aerating the anoxically treated wastewater; means for receiving the aerated wastewater from the aerating means; means for settling the aerated wastewater; means for internally pumping sedimentation and settled wastewater from the settling means back to the anoxically treating means; means for mixing pumped sedimentation and settled wastewater with the treated wastewater in the anoxically treating means; and means for discharging an effluent wastewater from the settling means.

The one embodiment above can further include means for receiving the discharged effluent wastewater; means for filtering the effluent wastewater; means for treating the filtered effluent wastewater; and means for discharging a final effluent wastewater.

In one embodiment, a wastewater treatment plant includes means for receiving a volume of wastewater; means for pretreating the volume of wastewater to produce pretreated wastewater; means for receiving the pretreated wastewater from the pretreating means; means for anoxically treating the pretreated wastewater to produce anoxically treated wastewater; means for delivering an amount of an organic material and a first amount of an alkaline material in the anoxically treating means; means for maintaining a minimum temperature of the pretreated wastewater in the anoxically treating means; means for receiving the anoxically treated wastewater from the anoxically treating means; means for aerating the anoxically treated wastewater to produce aerated wastewater; means for measuring pH and dissolved oxygen levels of the pretreated wastewater in the anoxically treating means and in the anoxically treated wastewater in the aerating means; means for delivering at least one of a second amount of the organic material and a second amount of the alkaline material in the aerating means; means for receiving aerated wastewater from the aerating means; means for settling the aerated wastewater to produce settled wastewater; and for internally pumping sedimentation and settled wastewater from the settling means back to the anoxically treating means; means for mixing the pumped sedimentation and settled wastewater with the pretreated wastewater in the anoxically treating means; means for treating the settled wastewater to produce treated water; and means for discharging the treated wastewater as an effluent wastewater from the settling means.

In another embodiment, a wastewater treatment method for removing total nitrogen from an influent residential wastewater including: receiving an influent flow of a residential wastewater in a pretreatment chamber of a wastewater treatment apparatus; pretreating the residential wastewater in the pretreatment chamber to produce a pretreated wastewater; receiving the pretreated wastewater from the pretreatment chamber in an aeration chamber; measuring pH and dissolved oxygen levels in the pretreated wastewater in the aeration chamber and the pretreatment chamber; receiving a first amount of an organic carbon material in the aeration chamber to maintain a predefined ratio between the organic carbon level, total nitrogen level and BOD level of the pretreated wastewater in the aeration chamber; receiving a first amount of an alkaline material in the aeration chamber to maintain a predefined pH and a predefined ratio between the alkalinity and a total nitrogen level of the residential wastewater in the aeration chamber; performing a nitrification process and a denitrification process on the pretreated wastewater in the aeration chamber to convert ammonium to nitrogen gas to form an aeration treated wastewater; pumping sludge into the aeration chamber and mixing the sludge with the aeration treated wastewater; measuring pH and dissolved oxygen levels in the aeration treated wastewater in the aeration chamber; if needed, receiving a second amount of an organic carbon material in the aeration chamber to maintain a predefined ratio between the organic carbon level, total nitrogen level and BOD level of the pretreated wastewater in the aeration chamber; if needed, receiving a second amount of the alkaline material in the aeration chamber to maintain a predefined pH and a predefined ratio between the alkalinity and the total nitrogen level of the aerated treated wastewater in the aeration chamber; aerating the aeration treated wastewater in the aeration chamber to remove the nitrogen gas in the aeration treated wastewater to produce treated water; receiving the treated water in a settling chamber; and discharging the treated water from the settling chamber.

In another embodiment, a wastewater treatment method for removing total nitrogen from an influent residential wastewater including: receiving an influent flow of a residential wastewater in a pretreatment chamber of a wastewater treatment apparatus; pretreating the residential wastewater in the pretreatment chamber to produce a pretreated wastewater; receiving the pretreated wastewater from the pretreatment chamber in an aeration chamber; measuring pH and dissolved oxygen levels in the pretreated wastewater in at least one of the aeration chamber and the pretreatment chamber; determining whether to add supplements to the pretreatment chamber; if it is determined to add supplements to the pretreatment chamber, receiving at least one of an amount of an organic carbon material and/or an alkaline material in the pretreatment chamber based on the measured at least one of pH and dissolved oxygen levels of the aeration chamber and in the pretreatment chamber; determining whether to maintain a minimum temperature; if it is determined to maintain a minimum temperature, maintaining the minimum temperature in the aeration chamber and in the pretreatment chamber; receiving a first amount of an organic carbon material in the aeration chamber to maintain a predefined ratio between the organic carbon level, total nitrogen level and BOD level of the pretreated wastewater in the aeration chamber; receiving a first amount of an alkaline material in the aeration chamber to maintain a predefined pH and a predefined ratio between the alkalinity and a total nitrogen level of the residential wastewater in the aeration chamber; performing a nitrification process and a denitrification process on the pretreated wastewater in the aeration chamber to convert ammonium to nitrogen gas to form an aeration treated wastewater; pumping sludge into the pretreatment chamber and mixing the sludge with the pretreated treated wastewater in the pretreatment chamber; determining whether conditions suggest adding bacteria; if conditions suggest adding bacteria, adding an amount of bacteria to the aeration chamber based on the determined conditions; measuring pH and dissolved oxygen levels in the aeration treated wastewater in the aeration chamber; if additional organic carbon material is determined to be needed, receiving a second amount of the organic carbon material in the aeration chamber to maintain a predefined ratio between the organic carbon level, total nitrogen level and BOD level of the pretreated wastewater in the aeration chamber; if additional alkaline material is determined to be needed, receiving a second amount of the alkaline material in the aeration chamber to maintain a predefined pH and a predefined ratio between the alkalinity and the total nitrogen level of the aerated treated wastewater in the aeration chamber; aerating the aeration treated wastewater in the aeration chamber to remove the nitrogen gas in the aeration treated wastewater to produce treated water; receiving the treated water in a settling chamber; determining whether the treated water in the settling chamber needs additional treatment; if additional treatment of the treated water in the settling chamber is determined to be needed, further treating the treated water in the settling chamber; and discharging the treated water from the settling chamber.

In another embodiment, a wastewater treatment system for removing total nitrogen from an influent residential wastewater including: means for receiving a volume of wastewater; means for pretreating the volume of wastewater to produce pretreated wastewater; means for receiving the pretreated wastewater from the pretreating means; means for aeration treating the pretreated wastewater to produce aeration treated wastewater; means for measuring pH and dissolved oxygen levels of the pretreated wastewater in at least one of the aeration treating means and the pretreating means; means for optionally delivering at least one of an amount of the organic material and an amount of the alkaline material in the pretreating means; means for delivering at least one of an amount of an organic material and an amount of an alkaline material in the aeration treating means; means for maintaining a minimum temperature of the aeration treated wastewater in the aeration treating means; means for delivering at least one of an amount of the organic material and an amount of the alkaline material in the aeration treating means; means for performing a nitrification process and a denitrification process on the pretreated wastewater in the aeration treating means to convert ammonium to nitrogen gas to form an aeration treated wastewater; means for pumping sludge into one of the pretreatment means and mixing the sludge with the pretreated wastewater in the pretreatment means, and the aeration treating means and mixing the sludge with the aeration treated wastewater in the aeration treating means; means for receiving aeration treated wastewater from the aeration treating means; means for settling the aeration treated wastewater to produce settled wastewater; means for internally pumping sedimentation and settled wastewater from the settling means back to the aeration treating means; means for mixing the pumped sedimentation and settled wastewater with the pretreated wastewater in the aeration treating means; means for treating the settled wastewater to produce treated water; and means for discharging the treated wastewater as an effluent wastewater from the settling means.

In a further embodiment, a wastewater treatment plant as herein illustrated and described. In a further embodiment, a wastewater treatment method as herein illustrated and described. In a still further embodiment, a wastewater treatment means as herein illustrated and described.

While the invention(s) has/have been described in conjunction with a number of embodiments, it is evident that many alternatives, modifications and variations would be or are apparent to those of ordinary skill in the applicable arts. For example, different component designs and/or elements only shown in association with a particular embodiment also may be used with the other embodiments. Accordingly, Applicant intends to embrace all such alternatives, modifications, equivalents, and variations that are within the spirit and scope of the invention(s) described herein.

What is claimed is:

1. A wastewater treatment method for removing total nitrogen from an influent residential wastewater comprising:
receiving an influent flow of a residential wastewater in a pretreatment chamber of a wastewater treatment apparatus;
pretreating the residential wastewater in the pretreatment chamber to produce a pretreated wastewater;
receiving the pretreated wastewater from the pretreatment chamber in an anoxic chamber;
measuring pH and dissolved oxygen levels in the pretreated wastewater in the anoxic chamber and in wastewater in an aeration chamber;
receiving a first amount of an organic carbon material in the anoxic chamber to maintain a predefined ratio between the organic carbon level, total nitrogen level and BOD level of the pretreated wastewater in the anoxic chamber;
receiving a first amount of an alkaline material in the anoxic chamber to maintain a predefined pH and a predefined ratio between the alkalinity and a total nitrogen level of the residential wastewater in the anoxic chamber;
performing a nitrification process and a denitrification process on the pretreated wastewater in the anoxic chamber to convert ammonium to nitrogen gas to form an anoxically treated wastewater;
pumping sludge into the pretreatment chamber and mixing the sludge with the pretreated treated wastewater in the pretreatment chamber;
receiving the anoxically treated wastewater from the anoxic chamber in an aeration chamber;
measuring pH and dissolved oxygen levels in the anoxically treated wastewater in the aeration chamber;
receiving at least one of a second amount of the organic material to maintain a predefined ratio between the organic carbon level, total nitrogen level and BOD level of the pretreated wastewater in the aeration chamber and a second amount of the alkaline material in the aeration chamber to maintain a predefined pH and a predefined ratio between the alkalinity and the total nitrogen level of the anoxically treated wastewater in the aeration chamber;
aerating the anoxically treated wastewater in the aeration chamber to remove the nitrogen gas in the anoxically treated wastewater to produce treated water;
receiving the treated water in a settling chamber; and
discharging the treated water from the settling chamber.

2. The wastewater treatment method of claim 1 further comprising:
maintaining a minimum temperature of the pretreated wastewater in the anoxic chamber; and
pumping sludge into the anoxic chamber and mixing the sludge with the pretreated wastewater.

3. The wastewater treatment method of claim 1 wherein the receiving a first amount of an organic carbon material in the anoxic chamber to maintain a predefined ratio between the organic carbon level, the total nitrogen level and BOD level of the pretreated wastewater in the anoxic chamber comprises:
receiving the first amount of the organic carbon material in the anoxic chamber adjacent to the inlet of the anoxic chamber from a first dispenser based on the measured pH of the anoxic chamber to maintain a predefined ratio between the organic carbon level, the total nitrogen level and BOD level of the pretreated wastewater in the anoxic chamber.

4. The wastewater treatment method of claim 3 wherein the ratio of the added organic carbon to alkaline material is in a range from 2:1 to 7.5:1.

5. The wastewater treatment method of claim 3 wherein the ratio of organic carbon to alkaline material added is in a range from 2:1 to 7.5:1 when the organic carbon and the alkaline material are dosed from the same dispenser.

6. The wastewater treatment method of claim 3 wherein the receiving a first amount of an alkaline material in the anoxic chamber to maintain a predefined pH and a predefined ratio between the pH and a total nitrogen level of the pretreated wastewater in the anoxic chamber comprises:
receiving the first amount of the alkaline material in the anoxic chamber adjacent to the outlet of the anoxic chamber from a second dispenser based on the measured pH of the anoxic chamber to maintain a predefined pH and a predefined ratio between the pH and a total nitrogen level of the pretreated wastewater in the anoxic chamber.

7. The wastewater treatment method of claim 6 wherein the receiving a second amount of the alkaline material in the aeration chamber to maintain a predefined pH and a predefined ratio between the alkalinity and the total nitrogen level of the anoxically treated wastewater in the aeration chamber comprises:
receiving the second amount of the alkaline material in the aeration chamber from a third dispenser based on the measured pH of the aeration chamber to maintain the predefined pH and the predefined ratio between the alkalinity and the total nitrogen level of the anoxically treated wastewater in the aeration chamber.

8. The wastewater treatment method of claim 1 wherein the performing a nitrification process and a denitrification process on the residential wastewater in the anoxic chamber to convert ammonium to nitrogen gas further comprises:
adding an amount of at least one bacteria to the anoxic chamber.

9. The wastewater treatment method of claim 8 wherein the adding an amount of at least one bacteria to the anoxic chamber further comprises:
adding the amount of the at least one bacteria to the anoxic chamber based on the measured conditions of the pretreated wastewater/sewage in the anoxic chamber.

10. The wastewater treatment method of claim 8 wherein the adding an amount of the at least one bacteria to the anoxic chamber further comprises:
adding the amount of the at least one bacteria to the anoxic chamber based on the measured conditions of the anoxically treated wastewater/sewage in the aeration chamber.

11. The wastewater treatment method of claim 1 wherein the alkalinity of the residential wastewater in the anoxic chamber is maintained between 100 to 250 ppm.

12. A wastewater treatment method for removing total nitrogen from an influent residential wastewater comprising:
receiving and pretreating an influent flow of a residential wastewater in a pretreatment chamber of a wastewater treatment apparatus to produce a pretreated wastewater;
receiving the pretreated wastewater from the pretreatment chamber in an anoxic chamber;
maintaining a minimum temperature of the pretreated wastewater in the anoxic chamber;
measuring pH and dissolved oxygen levels in the pretreated wastewater in the anoxic chamber and an aeration chamber;
receiving an organic carbon material in the anoxic chamber adjacent to the inlet of the anoxic chamber from a first dispenser based on the measured pH of the anoxic chamber to maintain a predefined ratio between the organic carbon level and the total nitrogen level of the pretreated wastewater in the anoxic chamber;
receiving a first amount of an alkaline material in the anoxic chamber adjacent to an outlet of the anoxic chamber from a second dispenser based on the measured pH of the anoxic chamber to maintain a predefined pH and a predefined ratio between the pH and a total nitrogen level of the pretreated wastewater in the anoxic chamber;
performing a nitrification process and a denitrification process on the pretreated wastewater in the anoxic chamber to convert ammonium to nitrogen gas by adding at least one bacteria to the anoxic chamber to create anoxically treated wastewater;
receiving the anoxically treated wastewater from the anoxic chamber in the aeration chamber;
measuring pH and dissolved oxygen levels in the anoxically treated wastewater in an aeration chamber;
receiving at least one of a second amount of the organic material to maintain the predefined ratio between the organic carbon level, total nitrogen level and BOD level of the pretreated wastewater in the aeration chamber and a second amount of the alkaline material in the aeration chamber from a third dispenser, based on the measured pH of the aeration chamber to maintain the predefined pH and a predefined ratio between the pH and the total nitrogen level of the anoxically treated wastewater in the aeration chamber;
aerating the anoxically treated wastewater in the aeration chamber to remove the nitrogen gas in the residential wastewater to produce treated wastewater;
receiving the treated wastewater in a settling chamber; returning sludge from the settling chamber to the anoxic chamber; and
discharging the treated wastewater from the settling chamber.

13. The wastewater treatment method of claim 12 wherein the ratio of the added organic carbon to alkaline material is in a range from 2:1 to 7.5:1.

14. The wastewater treatment method of claim 12 wherein the ratio of organic carbon to alkaline material added is in a range from 2:1 to 7.5:1 when the organic carbon and the alkaline material are dosed from the same dispenser.

15. The wastewater treatment method of claim 12 wherein the adding at least one bacteria to the anoxic chamber further comprises:
adding the at least one bacteria to the anoxic chamber based on the measured conditions of pretreated wastewater/sewage in the anoxic chamber.

16. The wastewater treatment method of claim 15 wherein the adding at least one bacteria to the anoxic chamber further comprises:
adding the at least one bacteria to the anoxic chamber based on the measured conditions of the anoxically treated wastewater/sewage in the aeration chamber.

17. The wastewater treatment method of claim 12 wherein the alkalinity of the residential wastewater in the anoxic chamber is maintained between 100 to 250 ppm.

18. A wastewater treatment system for removing total nitrogen from an influent residential wastewater comprising:
means for receiving a volume of wastewater;
means for pretreating the volume of wastewater to produce pretreated wastewater;
means for receiving the pretreated wastewater from the pretreating means;
means for anoxically treating the pretreated wastewater to produce anoxically treated wastewater;
means for delivering an amount of an organic material and a first amount of an alkaline material in the anoxically treating means;
means for maintaining a minimum temperature of the pretreated wastewater in the anoxically treating means;
means for receiving the anoxically treated wastewater from the anoxically treating means;
means for aerating the anoxically treated wastewater to produce aerated wastewater;
means for measuring pH and dissolved oxygen levels of the pretreated wastewater in the anoxically treating means and in the anoxically treated wastewater in the aerating means;
means for delivering at least one of a second amount of the organic material and second amount of the alkaline material in the aerating means;
means for receiving aerated wastewater from the aerating means;
means for settling the aerated wastewater to produce settled wastewater; and for internally pumping sedimentation and settled wastewater from the settling means back to the anoxically treating means;
means for mixing the pumped sedimentation and settled wastewater with the pretreated wastewater in the anoxically treating means;
means for treating the settled wastewater to produce treated water; and
means for discharging the treated wastewater as an effluent wastewater from the settling means.

19. The wastewater treatment system of claim 18 wherein the means for delivering an amount of an organic material and a first amount of an alkaline material in the anoxically treating means comprises:
means for automatically delivering the organic material; and
means for automatically delivering the alkaline material.

20. The wastewater treatment system of claim 19 wherein the means for automatically delivering the organic material comprises:
a single dispenser for delivering the organic material.

21. The wastewater treatment system of claim 19 wherein the means for automatically delivering the alkaline material comprises:
a single dispenser for delivering the alkaline material.

22. The wastewater treatment system of claim 18 wherein the means for delivering an amount of an organic material and a first amount of an alkaline material in the anoxically treating means comprises:
a single dispenser for delivering both the organic material and the alkaline material.

23. The wastewater treatment system of claim 22 wherein the single dispenser for delivering both the organic material and the alkaline material comprises:
a single dispenser configured to deliver twice as much of the organic material as the alkaline material.

24. A wastewater treatment method for removing total nitrogen from an influent residential wastewater comprising:
receiving an influent flow of a residential wastewater in a pretreatment chamber of a wastewater treatment apparatus;
pretreating the residential wastewater in the pretreatment chamber to produce a pretreated wastewater;
receiving the pretreated wastewater from the pretreatment chamber in an aeration chamber;
measuring pH and dissolved oxygen levels in the pretreated wastewater in the aeration chamber and the pretreatment chamber;
receiving a first amount of an organic carbon material in the aeration chamber to maintain a predefined ratio between the organic carbon level, total nitrogen level and BOD level of the pretreated wastewater in the aeration chamber;
receiving a first amount of an alkaline material in the aeration chamber to maintain a predefined pH and a predefined ratio between the alkalinity and a total nitrogen level of the residential wastewater in the aeration chamber;
performing a nitrification process and a denitrification process on the pretreated wastewater in the aeration chamber to convert ammonium to nitrogen gas to form an aeration treated wastewater;
pumping sludge into the aeration chamber and mixing the sludge with the aeration treated wastewater;
measuring pH and dissolved oxygen levels in the aeration treated wastewater in the aeration chamber;
if needed, receiving a second amount of an organic carbon material in the aeration chamber to maintain a predefined ratio between the organic carbon level, total nitrogen level and BOD level of the pretreated wastewater in the aeration chamber;
if needed, receiving a second amount of the alkaline material in the aeration chamber to maintain a predefined pH and a predefined ratio between the alkalinity and the total nitrogen level of the aerated treated wastewater in the aeration chamber;
aerating the aeration treated wastewater in the aeration chamber to remove the nitrogen gas in the aeration treated wastewater to produce treated water;
receiving the treated water in a settling chamber; and
discharging the treated water from the settling chamber.

25. The wastewater treatment method of claim 24 further comprising:
determining whether a minimum temperature needs to be maintained; and
if a minimum temperature needs to be maintained, maintaining the minimum temperature of the pretreated wastewater in the aeration chamber.

26. The wastewater treatment method of claim 24 wherein the receiving an organic carbon material in the aeration chamber to maintain a predefined ratio between the organic carbon level, the total nitrogen level and BOD level of the pretreated wastewater in the aeration chamber comprises:
receiving the organic carbon material in the aeration chamber adjacent to the inlet of the aeration chamber from a first dispenser based on the measured pH of the aeration chamber to maintain a predefined ratio between the organic carbon level, the total nitrogen level and BOD level of the pretreated wastewater in the aeration chamber.

27. The wastewater treatment method of claim 26 wherein the ratio of the added organic carbon to alkaline material ranges from 2:1 to 7.5:1.

28. The wastewater treatment method of claim 26 wherein the ratio of organic carbon to alkaline material added ranges from 2:1 to 7.5:1 when the organic carbon and the alkaline material are dosed from the same dispenser.

29. The wastewater treatment method of claim 26 wherein the receiving a first amount of an alkaline material in the aeration chamber to maintain a predefined pH and a predefined ratio between the pH and a total nitrogen level of the pretreated wastewater in the aeration chamber comprises:
receiving the first amount of the alkaline material in the aeration chamber adjacent to the outlet of the aeration chamber from a second dispenser based on the measured pH of the aeration chamber to maintain a predefined pH and a predefined ratio between the pH and a total nitrogen level of the pretreated wastewater in the aeration chamber.

30. The wastewater treatment method of claim 29 wherein the receiving a second amount of the alkaline material in the aeration chamber to maintain a predefined pH and a predefined ratio between the alkalinity and the total nitrogen level of the aeration treated wastewater in the aeration chamber comprises:
receiving the second amount of the alkaline material in the aeration chamber from a third dispenser based on the measured pH of the aeration chamber to maintain the predefined pH and the predefined ratio between the alkalinity and the total nitrogen level of the aeration treated wastewater in the aeration chamber.

31. The wastewater treatment method of claim 24 wherein the performing a nitrification process and a denitrification process on the residential wastewater in the aeration chamber to convert ammonium to nitrogen gas further comprises:
adding an amount of at least one bacteria to the aeration chamber.

32. The wastewater treatment method of claim 31 wherein the adding an amount of at least one bacteria to the aeration chamber further comprises:
adding the amount of the at least one bacteria to the aeration chamber based on the measured conditions of the pretreated wastewater/sewage in the aeration chamber.

33. The wastewater treatment method of claim 31 wherein the adding an amount of the at least one bacteria to the aeration chamber further comprises:
adding the amount of the at least one bacteria to the aeration chamber based on the measured conditions of the aeration treated wastewater/sewage in the aeration chamber.

34. The wastewater treatment method of claim 24 wherein the alkalinity of the residential wastewater in the aeration chamber is maintained between 100 to 250 ppm.

35. The wastewater treatment method of claim 24 wherein the pumping sludge into the aeration chamber and mixing the sludge with the aeration treated wastewater further comprises:
pumping the sludge into a middle of the aeration chamber adjacent to a level of the aeration treated wastewater and mixing the sludge with the aeration treated wastewater.

36. The wastewater treatment method of claim 24 wherein the aerating the aeration treated wastewater in the aeration chamber to remove the nitrogen gas in the aeration treated wastewater to produce treated water further comprises:
aerating the aeration treated wastewater in the aeration chamber adjacent to a level of the aeration treated wastewater and mixing the sludge with the aeration treated wastewater.

37. The wastewater treatment method of claim 36 wherein the aerating the aeration treated wastewater in the aeration chamber adjacent to a level of the aeration treated wastewater and mixing the sludge with the aeration treated wastewater further comprises:
aerating the aeration treated wastewater in the aeration chamber spaced apart from where the sludge is pumped back into the aeration chamber.

38. The wastewater treatment method of claim 24 further comprises:
further treating the treated wastewater in the settling chamber prior to discharging the treated water from the settling chamber.

39. The wastewater treatment method of claim 24 wherein the further treating the treated wastewater in the settling chamber prior to discharging the treated water from the settling chamber comprises:
further treating the treated wastewater in the settling chamber using flow equalization and filtration.

40. The wastewater treatment method of claim 39 wherein the further treating the treated wastewater in the settling chamber using flow equalization and filtration comprises:
further treating the treated wastewater in the settling chamber using chemicals and/or ultraviolet light.

41. A wastewater treatment method for removing total nitrogen from an influent residential wastewater comprising:
receiving an influent flow of a residential wastewater in a pretreatment chamber of a wastewater treatment apparatus;
pretreating the residential wastewater in the pretreatment chamber to produce a pretreated wastewater;
receiving the pretreated wastewater from the pretreatment chamber in an aeration chamber;
measuring pH and dissolved oxygen levels in the pretreated wastewater in at least one of the aeration chamber and the pretreatment chamber;
determining whether to add supplements to the pretreatment chamber;
if it is determined to add supplements to the pretreatment chamber, receiving at least one of an amount of an organic carbon material and an alkaline material in the pretreatment chamber based on the measured at least one of pH and dissolved oxygen levels of the aeration chamber and in the pretreatment chamber;
determining whether to maintain a minimum temperature;
if it is determined to maintain a minimum temperature, maintaining the minimum temperature in the aeration chamber and in the pretreatment chamber;
receiving a first amount of an organic carbon material in the aeration chamber to maintain a predefined ratio between the organic carbon level, total nitrogen level and BOD level of the pretreated wastewater in the aeration chamber;
receiving a first amount of an alkaline material in the aeration chamber to maintain a predefined pH and a predefined ratio between the alkalinity and a total nitrogen level of the residential wastewater in the aeration chamber;
performing a nitrification process and a denitrification process on the pretreated wastewater in the aeration chamber to convert ammonium to nitrogen gas to form an aeration treated wastewater;
pumping sludge into the pretreatment chamber and mixing the sludge with the pretreated treated wastewater in the pretreatment chamber;
determining whether conditions suggest adding bacteria;
if conditions suggest adding bacteria, adding an amount of bacteria to the aeration chamber based on the determined conditions;
measuring pH and dissolved oxygen levels in the aeration treated wastewater in the aeration chamber;
if additional organic carbon material is determined to be needed, receiving a second amount of the organic carbon material in the aeration chamber to maintain a predefined ratio between the organic carbon level, total nitrogen level and BOD level of the pretreated wastewater in the aeration chamber;
if additional alkaline material is determined to be needed, receiving a second amount of the alkaline material in the aeration chamber to maintain a predefined pH and a predefined ratio between the alkalinity and the total nitrogen level of the aerated treated wastewater in the aeration chamber;
aerating the aeration treated wastewater in the aeration chamber to remove the nitrogen gas in the aeration treated wastewater to produce treated water;
receiving the treated water in a settling chamber;
determining whether the treated water in the settling chamber needs additional treatment;
if additional treatment of the treated water in the settling chamber is determined to be needed, further treating the treated water in the settling chamber; and
discharging the treated water from the settling chamber.

42. The wastewater treatment method of claim 41 wherein the receiving an organic carbon material in the aeration chamber to maintain a predefined ratio between the organic carbon level, the total nitrogen level and BOD level of the pretreated wastewater in the aeration chamber comprises:
receiving the organic carbon material in the aeration chamber adjacent to the inlet of the aeration chamber from a first dispenser based on the measured pH of the aeration chamber to maintain a predefined ratio between the organic carbon level, the total nitrogen level and BOD level of the pretreated wastewater in the aeration chamber.

43. The wastewater treatment method of claim 42 wherein the ratio of the added organic carbon to alkaline material ranges from 2:1 to 7.5:1.

44. The wastewater treatment method of claim 42 wherein the ratio of organic carbon to alkaline material added ranges from 2:1 to 7.5:1 when the organic carbon and the alkaline material are dosed from the same dispenser.

45. The wastewater treatment method of claim 42 wherein the receiving a first amount of an alkaline material in the aeration chamber to maintain a predefined pH and a predefined ratio between the pH and a total nitrogen level of the pretreated wastewater in the aeration chamber comprises:
receiving the first amount of the alkaline material in the aeration chamber adjacent to the outlet of the aeration chamber from a second dispenser based on the measured pH of the aeration chamber to maintain a predefined pH and a predefined ratio between the pH and a total nitrogen level of the pretreated wastewater in the aeration chamber.

46. The wastewater treatment method of claim 45 wherein the receiving a second amount of the alkaline material in the aeration chamber to maintain a predefined pH and a predefined ratio between the alkalinity and the total nitrogen level of the aeration treated wastewater in the aeration chamber comprises:
receiving the second amount of the alkaline material in the aeration chamber from a third dispenser based on the measured pH of the aeration chamber to maintain the predefined pH and the predefined ratio between the alkalinity and the total nitrogen level of the aeration treated wastewater in the aeration chamber.

47. The wastewater treatment method of claim 41 wherein the performing a nitrification process and a denitrification process on the residential wastewater in the aeration chamber to convert ammonium to nitrogen gas further comprises:
adding an amount of at least one bacteria to the aeration chamber.

48. The wastewater treatment method of claim 47 wherein the adding an amount of at least one bacteria to the aeration chamber further comprises:
adding the amount of the at least one bacteria to the aeration chamber based on the measured conditions of the pretreated wastewater/sewage in the pretreatment chamber.

49. The wastewater treatment method of claim 47 wherein the adding an amount of the at least one bacteria to the aeration chamber further comprises:
adding the amount of the at least one bacteria to the aeration chamber based on the measured conditions of the aeration treated wastewater/sewage in the aeration chamber.

50. The wastewater treatment method of claim 41 wherein the alkalinity of the aerated wastewater in the aeration chamber is maintained between 100 to 250 ppm.

51. The wastewater treatment method of claim 41 wherein the pumping sludge into the aeration chamber and mixing the sludge with the aeration treated wastewater further comprises:
pumping the sludge into a middle of the aeration chamber adjacent to a level of the aeration treated wastewater and mixing the sludge with the aeration treated wastewater.

52. The wastewater treatment method of claim 41 wherein the aerating the aeration treated wastewater in the aeration chamber to remove the nitrogen gas in the aeration treated wastewater to produce treated water further comprises:
aerating the aeration treated wastewater in the aeration chamber adjacent to a level of the aeration treated wastewater and mixing the sludge with the aeration treated wastewater.

53. The wastewater treatment method of claim 52 wherein the aerating the aeration treated wastewater in the aeration chamber adjacent to a level of the aeration treated wastewater and mixing the sludge with the aeration treated wastewater further comprises:
aerating the aeration treated wastewater in the aeration chamber spaced apart from where the sludge is pumped back into the aeration chamber.

54. The wastewater treatment method of claim 41 wherein the further treating the treated wastewater in the settling chamber prior to discharging the treated water from the settling chamber comprises:
further treating the treated wastewater in the settling chamber using flow equalization and filtration.

55. The wastewater treatment method of claim 54 wherein the further treating the treated wastewater in the settling chamber using flow equalization and filtration comprises:
further treating the treated wastewater in the settling chamber using chemicals and/or ultraviolet light.

56. A wastewater treatment system for removing total nitrogen from an influent residential wastewater comprising:
means for receiving a volume of wastewater;
means for pretreating the volume of wastewater to produce pretreated wastewater;
means for receiving the pretreated wastewater from the pretreating means;
means for aeration treating the pretreated wastewater to produce aeration treated wastewater;
means for measuring pH and dissolved oxygen levels of the pretreated wastewater in at least one of the aeration treating means and the pretreating means;
means for optionally delivering at least one of an amount of the organic material and an amount of the alkaline material in the pretreating means;
means for delivering at least one of an amount of an organic material and an amount of an alkaline material in the aeration treating means;
means for maintaining a minimum temperature of the aeration treated wastewater in the aeration treating means;
means for delivering at least one of an amount of the organic material and an amount of the alkaline material in the aeration treating means;
means for performing a nitrification process and a denitrification process on the pretreated wastewater in the aeration treating means to convert ammonium to nitrogen gas to form an aeration treated wastewater;
means for pumping sludge into one of the pretreatment means and mixing the sludge with the pretreated wastewater in the pretreatment means, and the aeration treating means and mixing the sludge with the aeration treated wastewater in the aeration treating means;
means for receiving aeration treated wastewater from the aeration treating means;
means for settling the aeration treated wastewater to produce settled wastewater;
means for internally pumping sedimentation and settled wastewater from the settling means back to the aeration treating means;
means for mixing the pumped sedimentation and settled wastewater with the pretreated wastewater in the aeration treating means;
means for treating the settled wastewater to produce treated water; and
means for discharging the treated wastewater as an effluent wastewater from the settling means.

57. The wastewater treatment system of claim 56 wherein the means for delivering a first amount of an organic material and a first amount of an alkaline material in the aeration treating means comprises:
means for automatically delivering the organic material; and
means for automatically delivering the alkaline material.

58. The wastewater treatment system of claim 57 wherein the means for automatically delivering the organic material comprises:
a single dispenser for delivering the organic material.

59. The wastewater treatment system of claim 57 wherein the means for automatically delivering the alkaline material comprises:
a single dispenser for delivering the alkaline material.

60. The wastewater treatment system of claim 59 wherein the means for delivering a first amount of an organic material and a first amount of an alkaline material in the aeration treating means comprises:
a single dispenser for delivering both the organic material and the alkaline material.

61. The wastewater treatment system of claim 60 wherein the single dispenser for delivering both the organic material and the alkaline material comprises:
a single dispenser configured to deliver 2 to 7.5 times as much of the organic material as the alkaline material.
